(19) United States
(12) Patent Application Publication
(10) Pub. No.: US 2008/0120677 A1
(43) Pub. Date: May 22, 2008

(54) Method and system for ensuring continuous video services in a passive optical network

(76) Inventors: Marc R. Bernard, Miramar, FL (US); Timothy J. Doiron, Aurora, IL (US); David P. Fredrickson, Annandale, VA (US); Douglas F. Ortega, Potomac, MD (US); Charles E. Rothrauff, Sterling, VA (US); Thomas E. Conklin, Leesburg, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/891,852

(22) Filed: Aug. 13, 2007

Related U.S. Application Data
(63) Continuation-in-part of application No. 11/704,683, filed on Feb. 9, 2007.
Application No. 11/704,683 is a continuation-in-part of application No. 11/265,493, filed on Nov. 1, 2005.

(51) Int. Cl. H04N 7/173

(52) U.S. Cl. 725/129

(57) ABSTRACT

When an optical network terminal (ONT) is rebooted, for example, after being upgraded, the ONT may be not be ranged and provisioned for some time. This may disrupt services, such as video services provided to a customer. As such, a method and corresponding apparatus of ensuring continuous receipt of video services based on certain conditions in a passive optical network (PON) are provided. The method may include detecting at a PON element a condition indicating a change of states in receipt of video services, starting a timing mechanism having a default value stored in the PON element, and enabling receipt of video services at the PON element for an amount of time defined by the default value. Receipt of video services is enabled by maintaining video services at a second PON element and sending the video services to the PON element. In this way, disruption to video services is reduced.

### RELATED APPLICATIONS

This application is a continuation in part of U.S. application Ser. No. 11/704,683 entitled, “METHOD AND APPARATUS FOR PRESERVING INTERNET PROTOCOL VIDEO SERVICES ACROSS AN OPTICAL NETWORK ELEMENT REBOOT” filed on Feb. 9, 2007; which is a continuation in part of U.S. application Ser. No. 11/265,493 entitled, “METHOD AND APPARATUS FOR MAINTAINING ONT VIDEO BEHAVIOR DURING INITIAL ONT DEPLOYMENTS, ONT REBOOTS, AND LOSS OF OLT CONDITIONS” filed on Nov. 1, 2005. The entire teachings of the above applications are incorporated herein by reference.

### BACKGROUND OF THE INVENTION

In a passive optical network (PON), a central office (CO) may communicate with a subscriber terminal using three wavelengths: (i) an analog video wavelength, (ii) a digital downstream communications wavelength, and (iii) a digital upstream communications wavelength. There are times when the central office loses communications with the subscriber terminal, such as when the subscriber terminal is upgraded and/or rebooted. Services, such as Internet Protocol (IP) video services, which are provided to a customer, may be “down” (i.e. interrupted or disabled) while the subscriber terminal is rebooting and waiting to be re-ranged, referred to as “down-time.”The amount of “down-time” may be several minutes depending on, for example, the number of other subscriber terminals also being rebooted.

### SUMMARY OF THE INVENTION

A method and corresponding apparatus according to one embodiment of the present invention includes: (i) detecting at a passive optical network (PON) element a condition indicating a change of state(s) in video services, (ii) starting a timing mechanism having a default value stored in the PON element, and (iii) enabling receipt of video services at the PON element for an amount of time defined by the default value. The receipt of video services at the PON element is enabled for the amount of time defined by the default value by: (i) maintaining at a second PON element a configuration for video services and (ii) sending video services to the PON element according to the maintained configuration for video services.

### BRIEF DESCRIPTION OF THE DRAWINGS

The foregoing and other objects, features and advantages of the invention will be apparent from the following more particular description of example embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of an example Passive Optical Network (PON) in which an optical network terminal (ONT) continues to provide video services for a limited length of time to a subscriber when an active communications link exists between a PON card and the ONT;

FIG. 2 is a block diagram of an ONT in accordance with embodiments of the present invention;

FIG. 3 is a flowchart of an example process performed by an ONT in accordance with embodiments of the present invention;

FIG. 4 is a flowchart of an example process performed by an ONT in accordance with embodiments of the present invention;

FIG. 5 is a flowchart of an example process performed by an ONT in accordance with embodiments of the present invention;

FIG. 6 is a block diagram of an example passive optical network (PON) in which embodiments of the present invention may be employed;

FIG. 7 is a block diagram of an example passive optical network (PON) providing services over a shared fiber and distribution fibers;

FIG. 8 is a block diagram of an example passive optical network 800 providing services to customers over downstream communications between an OLT and ONTs;

FIG. 9 is a block diagram of an example passive optical network providing IP video services to customers over downstream communications paths which are unicast in nature;

FIG. 10 is a block diagram of an example passive optical network providing IP video services to customers over a downstream communications path which is broadcast in nature;

FIGS. 11A-C are message diagrams illustrating maintaining at least one video channel previously viewed in accordance with embodiments of the present invention;

FIG. 12 is a chart providing an overview of events occurring at an OLT, an ONT, and a set-top box/television at three different instances in time;

FIG. 13 is a flowchart for an example process for ensuring continuous video service based on conditions in a passive optical network, in accordance with an embodiment of the present invention;

FIGS. 14A and 14B are flowcharts for example processes for maintaining at least one most previously viewed video service while alleviating a problem of a stale maintained configuration for video services, in accordance with embodiments of the present illustrate invention; and

FIG. 15 is a block diagram that illustrates an example passive optical network (PON) element for ensuring continuous receipt of video services, in accordance with embodiments of the present invention.

FIG. 16 is a block diagram of an example passive optical network (PON) element maintaining a configuration for video service by responding to queries from a video services server, in accordance with an embodiment of the present invention;

FIG. 17 is a block diagram of an example passive optical network (PON) element maintaining a configuration for video services by updating a video services server, in accordance with an embodiment of the present invention;

FIG. 18 is a block diagram of an example passive optical network (PON) element receiving indications of video services being viewed, in accordance with embodiments of the present invention;

FIG. 19 is a flowchart of an example process for ensuring receipt of video services at a PON element for an amount of time defined by a default value, in accordance with an embodiment of the present invention; and

FIG. 20 is a block diagram of an example system to ensure receipt of video services at a PON element for an amount of time defined by a default value, in accordance with an embodiment of the present invention.

### DETAILED DESCRIPTION OF THE INVENTION

A description of example embodiments of the invention follows.

It is useful to a service provider to minimize an amount of time services, which are provided to a customer, such as Internet Protocol (IP) video services, are “down” or disrupted when the customer's subscriber terminal is rebooted or upgraded and waiting to be re-ranged. A method and corresponding apparatus for ensuring continuous receipt of video services based on certain conditions in a passive optical network (PON) is provided.

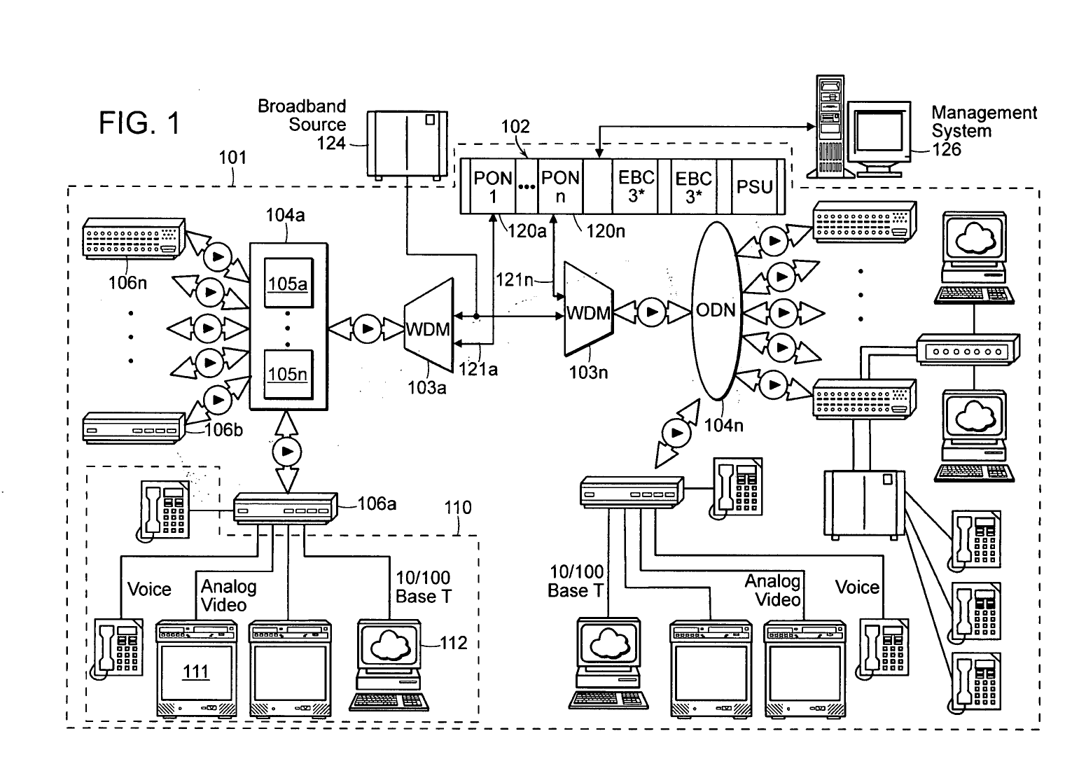

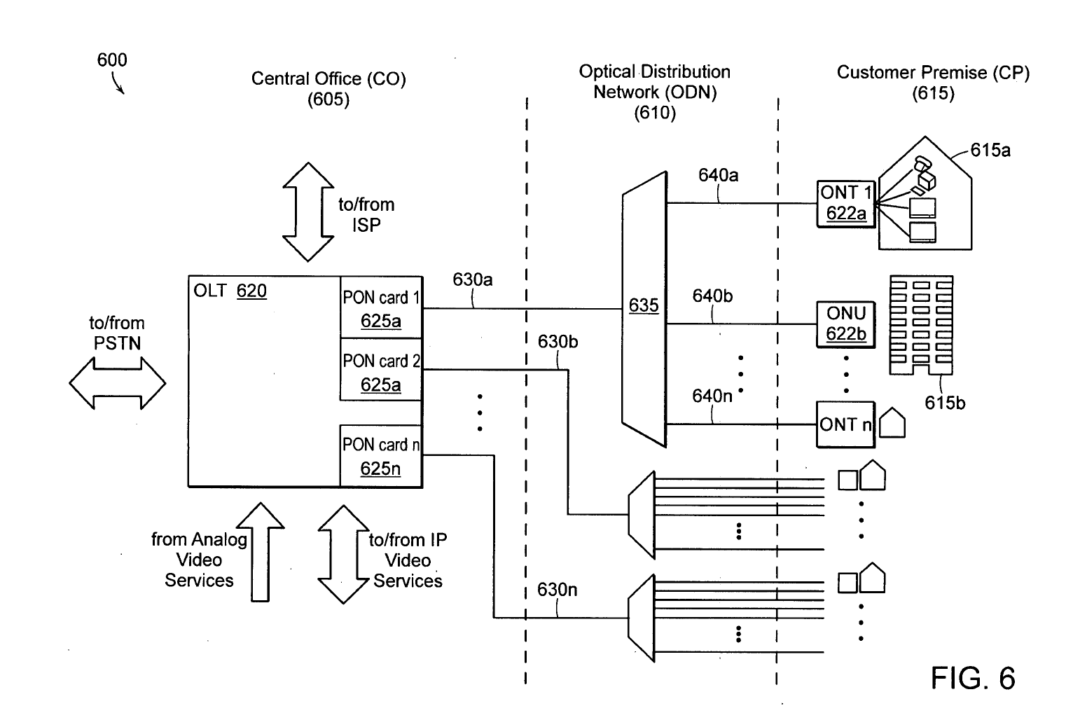

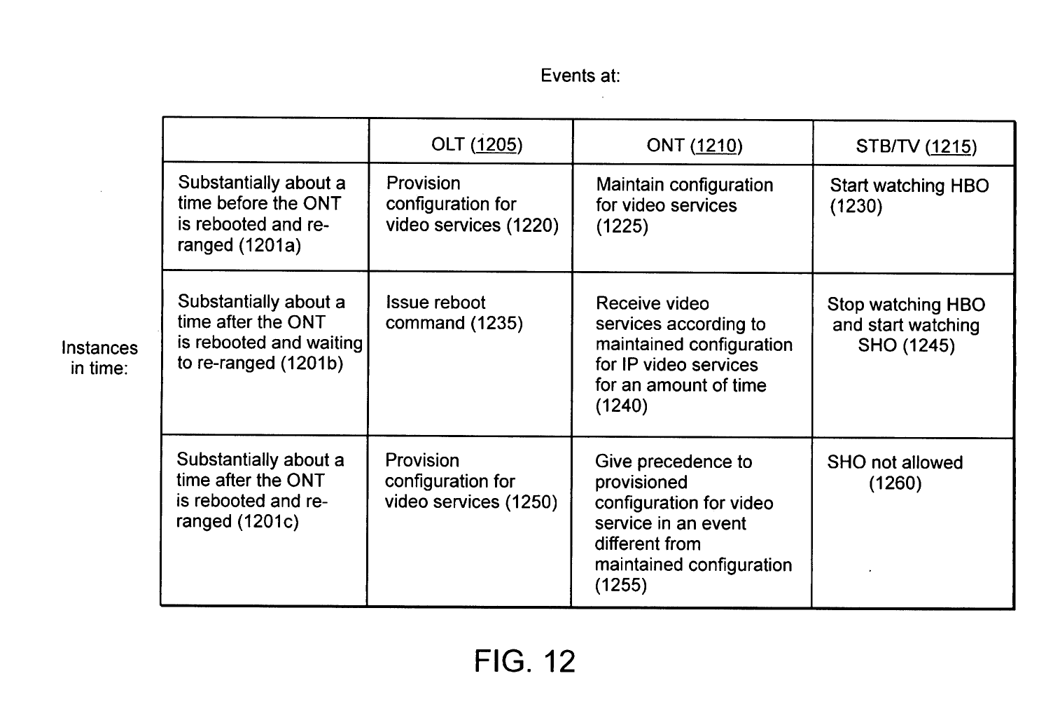

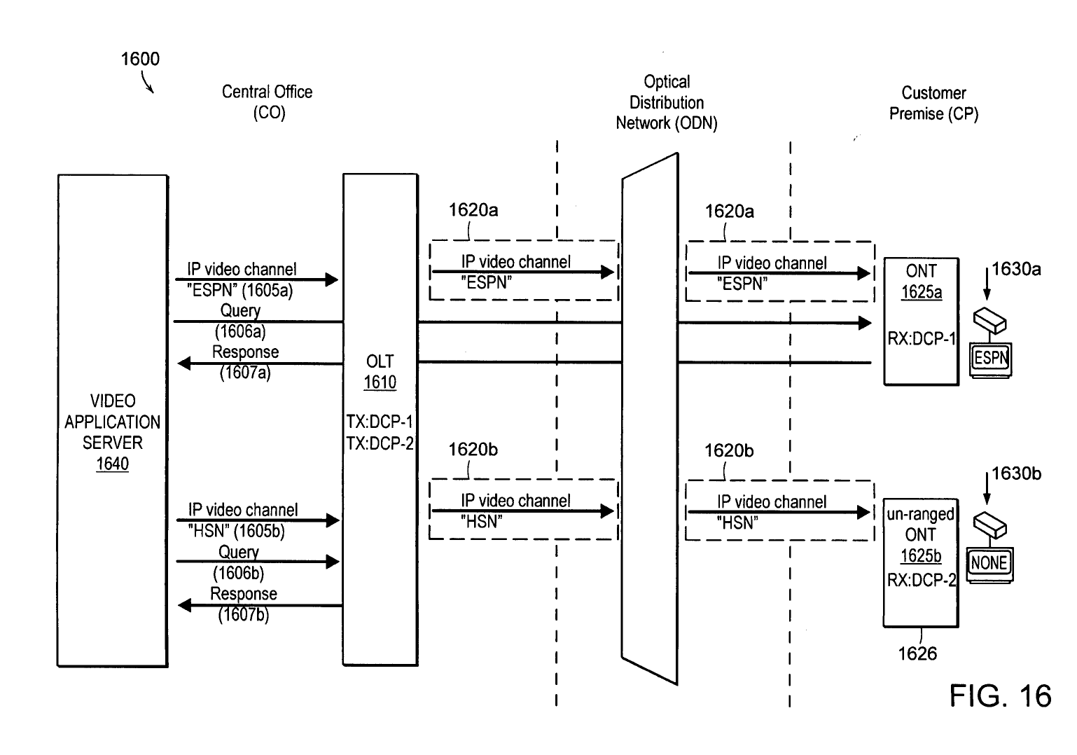

The following description is divided into four sections. The first section describes in reference to FIGS. 1-5 enabling receipt of video services at a passive optical network (PON) for a time defined by a default value. The second section describes in reference to FIGS. 6-11C a passive optical network (PON) in which example embodiments of the present invention may be deployed. The third section describes, in reference to FIGS. 12-15 enabling receipt of video service at a PON element, such as an optical network terminal (ONT), by maintaining at the PON element a configuration for video services. The fourth section describes, in reference to FIGS. 16-20 further enabling receipt of video services at the PON element by maintaining at a second PON element, such as an optical line terminal (OLT), a configuration for video services.

FIG. 1 is a network diagram of an exemplary passive optical network (PON) 101. The PON 101 includes an optical line terminal (OLT) 102, wavelength division multiplexers 103a, . . . , 103n, optical distribution network (ODN) devices 104a, . . . , 104n, ODN device splitters (e.g., 105a, . . . , 105n associated with ODN device 104a), optical network terminals (ONTs) (e.g., 106a, 106b, . . . , 106n corresponding to ODN device splitters 105a, . . . , 105n), and customer premises equipment (e.g., 110). The OLT 102 includes PON cards 120a, . . . , 120n, each of which provides an optical feed (121a, . . . , 121n) to ODN devices 104a, . . . , 104n. An optical feed 121a, for example, is distributed through a corresponding ODN device 104a by separate ODN device splitters 105a, . . . , 105n to respective ONTs 106a, 106b, . . . , 106n in order to provide communications to and from customer premises equipment 110.

The PON 101 may be deployed for fiber-to-the-business (FTTB), fiber-to-the-curb (FTTC), and fiber-to-the-home (FTTH) applications. The optical fibers 121a, . . . , 121n in PON 101 may operate at bandwidths such as 155 Mb/sec, 622 Mb/sec, 1.25 Gb/sec, 2.5 Gb/sec or any other desired bandwidth implementations. The PON 101 may incorporate asynchronous transfer mode (ATM) communications, broadband services such as Ethernet access and video distribution, Ethernet point-to-multipoint topologies, and native communications of data and time division multiplex (TDM) formats. Customer premises equipment (e.g., 110) that can receive and provide communications in the PON 101 may include standard telephones e.g., Public Switched Telephone Network (PSTN) and cellular, Internet Protocol (IP) telephones, Ethernet units, video devices (e.g., 111), computer terminals (e.g., 112), digital subscriber line connections, cable modems, wireless access, as well as any other conventional device.

A PON 101 includes one or more different types of ONTs (e.g., 106a, 106b, . . . , 106n). Each ONT 106a, 106b, . . . , 106n, for example, communicates with an ODN device 104a through associated ODN device splitters 105a, . . . , 105n. Each ODN device 104a, . . . , 104n, in turn, communicates with an associated PON card 120a, . . . , 120n through respective wavelength division multiplexers 103a, . . . , 103n. Communications between the ODN devices 104a, . . . , 104n and the OLT 102 occur over a downstream wavelength and an upstream wavelength. The downstream communications from the OLT 102 to the ODN devices 104a, . . . , 104n may be provided at 622 megabytes per second, which is shared across all ONTs connected to the ODN devices 104a, . . . , 104n. The upstream communications from the ODN devices 104a, . . . , 104n to the PON cards 120a, . . . , 120n may be provided at 155 megabytes per second, which is shared among all ONTs connected to ODN devices 104a, . . . , 104n.

A broadband source 124, of which a cable television feed through an erbium doped fiber amplifier (EDFA) is just one example, may also provide video or other broadband data to the WDMs 103a, . . . , 103n using a single wavelength (hereinafter, video wavelength). The WDMs 103a, . . . , 103n multiplex the PON upstream and downstream communications wavelengths and the video wavelength and provide the resulting multiplexed signals to respective ODN devices 104a, . . . , 104n. Each ONT (e.g., 106a, 106b, . . . , 106n) may monitor a broadband overlay signal provided by the broadband source 124. One example of a broadband overlay signal is a 1550 nanometer signal used for downstream video applications.

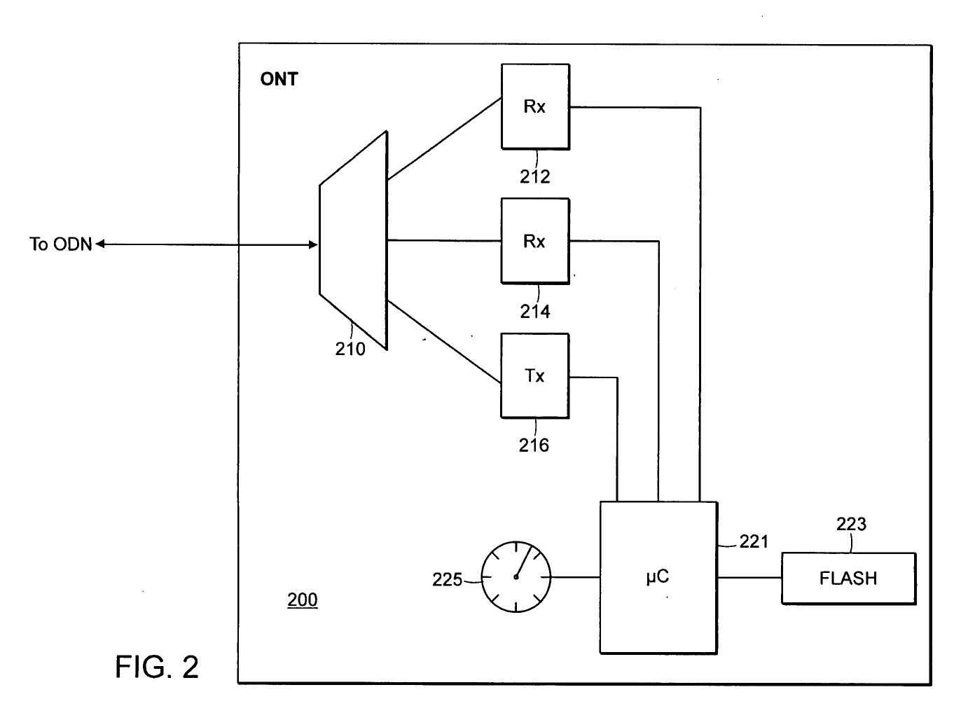

FIG. 2 is a block diagram of an ONT 200 according to an embodiment of the present invention. The ONT 200 comprises a splitter 210 which connects through a fiber to an ODN device splitter 105a of the optical network device 104a (FIG. 1). The splitter 210 may split the optical signal from the ODN device splitter into its three respective wavelengths (e.g., upstream and downstream communications wavelengths and the video or broadband data wavelength). Thus, the ONT 200 (i) receives video or broadband data 212, (ii) receives PON communications data, and (iii) transmits PON communications data 216. The ONT 200 further includes a microprocessor 221 which monitors and controls the transmission and receipt of the video and PON communications data. The microprocessor 221 is connected to non-volatile flash memory 223 which may be used to store settings of a video service mode according to an embodiment of the present invention. The microprocessor 221 is further connected to a timing mechanism 225, which may be used to enable video services for a given length of time.

In normal operation, a PON card of the OLT ranges an ONT to enable communications between the PON card and the ONT. Once the ONT is ranged, the PON card may provision the ONT to enable or disable video services to the ONT. In existing FTTP systems, however, the ONT may lose communications with the OLT for a variety of reasons.

First, there may be a fiber break in certain segments of the PON.

Second, the ONT may reboot, for example, in response to a command by the OLT. Reboots most often occur when the ONT is upgraded. The OLT may issue an element management system (EMS) command to the ONT to perform a hard reboot for troubleshooting purposes. The ONT may also reboot in response to actuating a switch on the ONT or in response to an internal command from the microprocessor.

Third, the ONT may lose communications with the OLT because there may be a problem in the OLT (e.g., a problem with a PON line card providing an OLT interface on the PON in which the ONT resides) or in the PON line cards (or other line cards that may be required to reboot or may be replaced with another line card). When the PON line card is replaced with another line card, the communication between the ONT and the OLT is lost, and an ONT loss of physical layer-loss of signal (ONT LOPL-LOS) condition occurs.

Fourth, the ONT may lose communications with the OLT because (i) there may be a bad connection between some ODN device splitters and a PON line card, which may cause high bit-error-rates; (ii) the ODN device splitter may simply lose connection with its corresponding ONT; or (iii) a misbehaving ONT (e.g., often referred to as a “rogue” ONT) may cause bad communications between all ONTs and the PON line card and thus cause all ONTs' ranging to go down.

Fifth, the ONT may lose communication with the OLT because, in some PON troubleshooting scenarios, the ONT may be commanded to perform an emergency stop (per ITU-G.983.1) (“E-STOP”) via the disable_serial_number PLOAM messages, at which point the ONT must stop regular communications with the OLT until commanded to come out of the emergency stop on state.

The above list of reasons why an ONT may lose communications with a PON line card is not meant to be an exhaustive list. There are many other reasons for loss of communications between an ONT and a PON line card. For whatever reason the ONT loses ranging with the OLT, the ONT defaults to its video service enabled or disabled mode whether or not the ONT is provisioned to offer video services to its subtended subscriber.

In the case when the ONT's default attribute for video services is enabled, a user can connect, via such an ONT in any PON network, to a video server (not shown) and receive video services at no charge from the service provider. Ideally, the service provider wants to change video services whether or not an ONT has lost communications with the OLT. In the case when the ONT's default video services mode is disabled (for example, when an ONT a shipped from a manufacturer), a field technician cannot connect an ONT to the PON to determine if the ONT even receives video. This is a useful troubleshooting technique in the home to ensure the ONT is functional and that fiber is linked to the home. Typically, an ONT defaults to the disabled video services mode.

According to an embodiment of the present invention, a mechanism is provided that allows the ONT to continue offering video services even when the ONT loses communications with the OLT (e.g., across reboots). In one embodiment, the ONT may maintain the last known Video Services Mode in flash memory. After an OLT loses ranging with an ONT, the ONT maintains the last known video service mode for a predetermined length of time as defined by a timing mechanism. In this way, after a timing duration or threshold, a user cannot connect an ONT in any PON network to receive free video services.

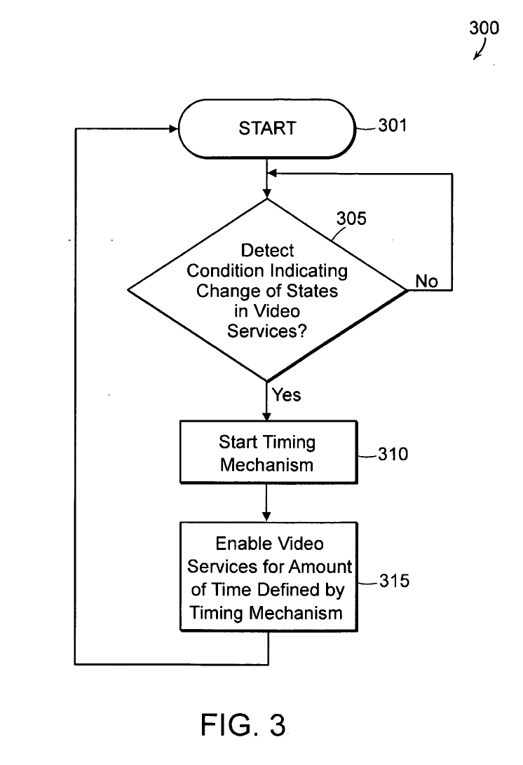

FIG. 3 is a flowchart of an example process 300 performed by an ONT in accordance with embodiments of the present invention. After starting (301) the process 300 determines whether or not the ONT detects (305) a condition indicating a change of states in video services. A condition indicating a change of states in video services may include any of the conditions listed above (i.e., reasons why an ONT loses communications with a PON card at the OLT). If the process 300 does not detect (305) a condition indicating a change of state in video services, then the process 300 repeats determining whether the ONT detects (305) a condition indicating a change of states and video services. If the process 300 does detect (305) such a condition, the process 300 (i) starts (310) a timing mechanism (e.g. clock 225, FIG. 2) and (ii) enables (315) video services for an amount of time defined by the timing mechanism. After an amount of time defined by the timing mechanism expires, the process 300 may resume a video service mode stored in memory before restarting (301) the process 300. For example, if the video service mode stored in memory is set to disabled, the process 300 disables video services.

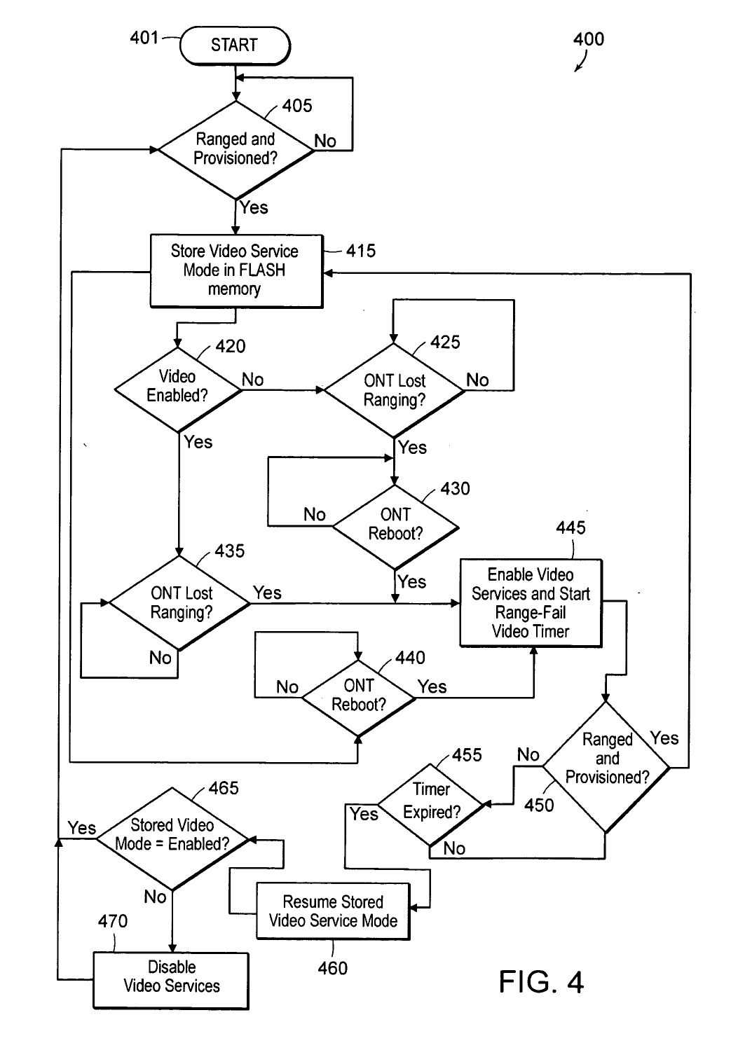

FIG. 4 is a flowchart of a detailed process 400 according to an embodiment of the present invention. The process 400 may be implemented in software, stored on a computer-readable medium (e.g., CD-ROM), and loaded and executed in the microprocessor of an ONT. After starting (401), the process 400 determines whether or not the ONT is ranged and provisioned (405) by the PON line card of the OLT. In a PON, after the PON line card ranges the ONT, it may provision the ONT to operate according to certain modes, such as a video service mode. In this way, a service provider may control the services being provided to the ONT. If the ONT has not been ranged and provisioned by the PON line card, the process 400 repeats to determine whether the ONT is ranged and provisioned (405).

If the ONT is ranged and provisioned (405), the process 400 stores (415) provisioned video service mode settings in the ONT's FLASH memory. An ONT in inventory may be provisioned with video service mode settings before being deployed, and, thus, the video service mode settings are stored in such an ONT's FLASH memory. Inventory may include new ONTs and used ONTs (e.g., refurbished ONTs ready for redeployment).

The process 400 next determines whether or not video services have been enabled (420). If video services have not been enabled (420), but instead they have been disabled, the process 400 proceeds to determine whether or not the ONT has lost ranging (425) with the PON line card. If the process 400 determines that the ONT has lost ranging (425) with the PON line card, the process 400 determines whether or not the ONT has been rebooted (430). If on the other hand, the process 400 determines that the ONT has not lost ranging (425) with the PON line card, the process 400 repeats determining whether the ONT has lost ranging (425).

If the ONT has lost ranging (425) and the ONT has not been rebooted (430), the process 400 continues checking for an ONT reboot (430). If the ONT has lost ranging (425) and the ONT has been rebooted (430), the process 400 enables (445) video services and starts a range-fail video timer, which may be set for a default amount of time. For example, the default amount of time may be sufficient for troubleshooting purposes or may be a value that is determined by the customer. Thus, the ONT does not need to be ranged by the OLT in order to provide video services for test or troubleshooting purposes. In a typical scenario, a technician is able to troubleshoot the ONT before the range fail video timer expires.

The default timer value may be a few minutes or many hours (e.g., 1 to 72 hours). The timer value may be stored in the ONT, for example, in FLASH memory. The timer value may also be updated, for example, locally by a technician or remotely by the Element Management System (EMS). The range-fail video timer may be any type of timing mechanism capable of measuring or provide information for measuring a given length of time such as a counter or a monitoring device monitoring a clock.

Referring again to the “video enabled” determination (420), after the process 400 determines that the video service mode has been set to enabled (420), the process 400 proceeds to determine whether or not the ONT has lost ranging (435) with the PON line card. If the ONT has indeed lost ranging (435) with the PON line card, the process 400 enables (445) video services and starts the range-fail video timer. If the ONT has not lost ranging (435) with the PON line card, the process 400 continues to monitor the state of ranging (435) between the ONT and the PON line card.

After the process 400 stores (415) the provisioned video service mode settings in FLASH memory, the process 400 monitors whether or not the ONT has rebooted (440). In other words, after the process 400 determines (440) that the ONT (or an ONT microprocessor) has not been rebooted, the process 400 repeats (440). Once the process 400 determines that the ONT has rebooted (440), the process 400 proceeds to enable video services and starts the range-fail video timer (445).

After the process 400 enables (445) video services and starts the range-fail video timer, the process 400 monitors (450) whether or not the ONT has been ranged and provisioned. If the ONT has been ranged and provisioned (450), the process 400 stores (415) the provisioned video service mode settings in the ONT's FLASH memory. If instead the ONT has not been ranged and provisioned (450), the process 400 proceeds to determine (455) whether or not the range-fail video timer has expired. If the range-fail video timer has not expired (455), the process 400 continues to monitor whether or not the ONT has been ranged and provisioned (450). However, if the range-fail video timer has expired (455), the process 400 resumes the video service mode (460) according to the video service mode settings stored in the FLASH memory. Next, the process 400 determines (465) whether or not the stored video service mode settings are set to enabled. If the video service mode is set to enable (465), the process 400 returns to determine (405) whether or not the ONT has been ranged or provisioned. Otherwise, the process 400 disables video services (470) and then returns to determine whether or not the ONT has been ranged for provisioned (405).

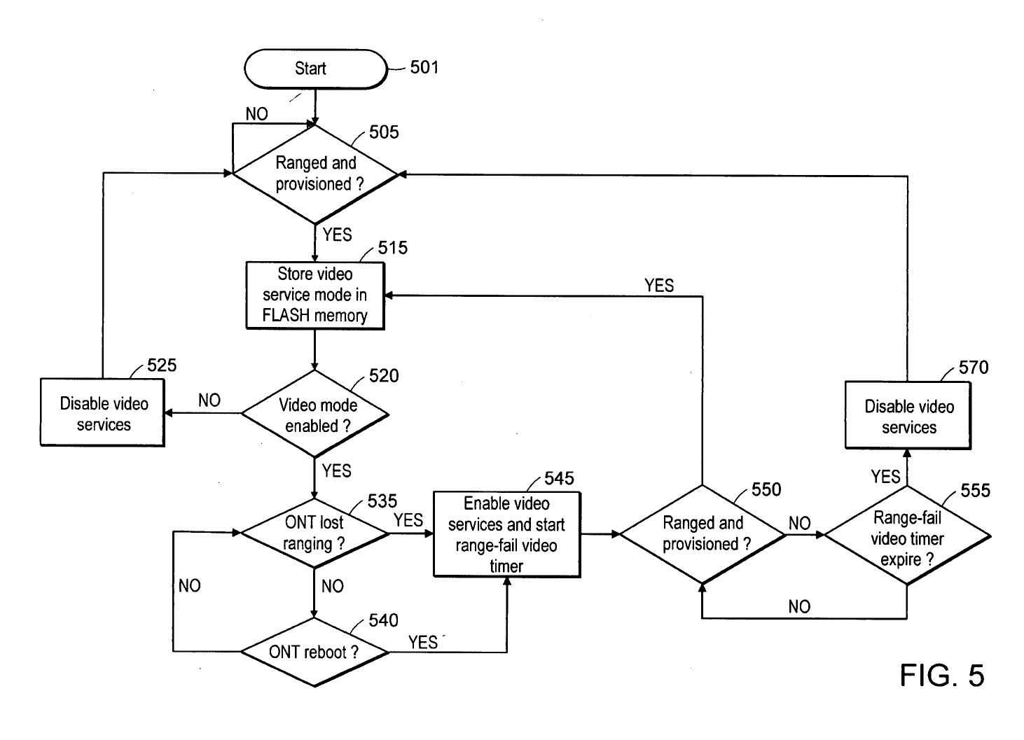

FIG. 5 is a flowchart of a process 500 according to another embodiment of the present invention. After starting (501), the process 500 determines whether or not an ONT has been ranged and provisioned (505) by a PON line card of the OLT. If the ONT has not been ranged and provisioned by the PON line card, the process 500 repeats to determine whether or not the ONT has been ranged and provisioned (505).

If the ONT is ranged and provisioned (505), the process 500 stores (515) the provisioned video service mode settings in the ONT's FLASH memory. The process 500 determines whether or not a video service mode has been set to enabled (520). If the video service mode has not been set to enabled, but instead has been set to disabled, the process 500 proceeds to disable video services (525) and returns to determine whether the ONT has been provisioned and ranged (505). Thus, a timing mechanism is disabled when the video service mode is set to disabled.

If the video service mode has been set to enabled (520), the process 500 proceeds to determine whether or not the ONT has lost ranging (535) with the PON line card. If the ONT has indeed lost ranging (535) with the PON line card, the process 500 enables video services and starts a range-fail video timer (545). If the ONT, however, has not lost ranging with the PON line card, the process 500 proceeds to determine whether or not the ONT has rebooted (540).

If the process 500 determines the ONT has not rebooted (540), the process 500 returns to determine whether or not the ONT has lost ranging (535) with the PON line card. If however, the process 500 determines the ONT has rebooted (540), the process 500 proceeds to enable video services and starts the range-fail video timer (545).

After the process 500 enables (545) video services and starts the range-fail video timer, the process 500 monitors (550) whether or not the ONT has been ranged and provisioned. If the ONT has been ranged and provisioned (550), the process 500 stores (515) the provisioned video service mode settings in the ONT's FLASH memory. If instead the ONT has not been ranged and provisioned (550), the process 500 proceeds to determine (555) whether or not the range-fail video timer has expired. If the range-fail video timer has not expired (555), the process 500 continues to monitor whether or not the ONT has been ranged and provisioned (550). However, if the range-fail video timer has expired (555), the process 500 disables (570) video services and then returns to determine whether the ONT has been ranged and provisioned (505).

It should be understood that video services may be disabled after a predetermined amount of time by, for example, disabling receipt of video services at the ONT or by disabling transmission of video services towards a customer or subscriber.

It should be further understood that the range-fail video timer should be sufficiently long enough to allow a technician to troubleshoot the ONT and ensure that the ONT is able to receive video services. Furthermore the range-fail video timer should be sufficiently long enough to detect, for example, a valid downstream 1550 mm signal from the PON line card. However, the length of time monitored by the timer should not be so long as to allow a customer to “steal” video services for extended periods of time. The length of time monitored by the timer should be short enough to make it inconvenient to watch any video services of programming.

FIGS. 6-11C are network and signal diagrams of a passive optical network (PON) supporting embodiments of the present invention. FIGS. 12-15 are diagrams and flowcharts illustrating example embodiments of the present invention.

FIG. 6 illustrates an example passive optical network (PON) 600 with a central office (CO) 605, optical distribution network (ODN) 610, and customer premise (CP) 615 in which embodiments of the present invention may be employed.

In one embodiment, continuous video services are ensured based on certain conditions in a passive optical network (PON) by detecting at a PON element a condition indicating a change of states in video services, triggering a timing mechanism having a default value stored in the PON element, and enabling receipt of video services at the PON element for an amount of time defined by the default value.

In some embodiments, receipt of video services at a PON element is enabled for an amount of time defined by a default value by maintaining a configuration for video services previously provisioned and receiving video services according to the maintained configuration for video services for the amount of time defined by the default value.

One embodiment maintains the configuration for video services previously provisioned by maintaining a state of receipt of the video services and maintaining at least one downstream communications path for video services for delivering the video services. Another embodiment further maintains a list of allowable video services and maintains at least one video service previously viewed.

While one embodiment receives video services according to the maintained configuration, another embodiment gives precedence to a configuration for video services provisioned by a second PON element, in an event the maintained configuration for video services differs from the configuration for video services provisioned by the second PON element.

In a particular embodiment, at least one video service previously viewed is maintained by monitoring for Internet Group Management Protocol (IGMP) Multicast Membership Report and IGMP Multicast Leave Group Membership messages, indicating a change from a first video service to a second video service. Alternatively, in another embodiment, at least one video service previously viewed is maintained by sending an IGMP Group Membership Query message to determine at least one video service requested.

To enable receipt of video services at the PON element for an amount of time defined by the default value, one embodiment additionally determines whether video services are available by monitoring a downstream communications path for available video services. Yet, another embodiment further determines whether video services are available by monitoring the downstream communications path for a message indicating video services are available.

One embodiment may maintain a configuration for video services previously provisioned by storing the configuration internally to a PON element.

In one embodiment, the change of states includes at least one of the following: fiber-break in certain segments of the PON, the PON element reboots for purposes of troubleshooting or upgrading the PON element, the PON card or other line card reboots or is replaced with another line card, poor connections with some Optical Distribution Network (ODN), and a misbehaving PON element causes bad communications between PON elements.

In another embodiment, the PON element enters a provisioned video service mode when the amount of time defined by the default value ends. The entered provisioned video service mode uses information provided by another PON element.

In yet another embodiment, the default value of the timing mechanism is changed from a remote or external source, is stored in nonvolatile memory, or combinations of thereof.

In still another embodiment, continuous video services are ensured by additionally returning the timing mechanism to its original state in an event a loss of ranging occurs. Alternatively, continuous video services are ensured by additionally disabling the receipt of video services after the amount of time defined by the timing mechanism expires.

Continuing to refer to FIG. 6, at the central office 605, an optical line terminal (OLT) 620 is communicatively connected or otherwise interfaced to, for example, an Internet service provider (ISP) (not shown), a public switched telephone network (PTSN) (not shown), video analog services, and IP video services. The OLT 620 includes passive optical network cards 625a . . . 625n.

Services such as data, telephony, and video are provided to customers over shared fibers 630a . . . 630n. At the optical distribution network 610, services provided over the shared fiber 630a . . . 630n are split by a splitter 635 onto two or more distribution fibers 640a . . . 640n.

Communications corresponding to provided services, which are going away from the central office 605 toward the customer premise 615, are hereinafter referred to as downstream communications. Conversely, communications corresponding to provided services, which going away from the customer premise 615 toward the central office 605, are hereinafter referred to as upstream communications.

Services may be deployed in fiber-to-the-home (FTTH), fiber-to-the premise (FTTP), or fiber-to-the-curb (FTTC) architectures. In the case of FTTH, at the customer premise 615, for example a home 615a, services are provided to the customer through an optical network terminal (ONT) 622a. In the case of FTTH, at the customer premise 615, for example an apartment 615b or other multi-dwelling unit (MDU), services are provided to the customers by an optical network unit (ONU) 622b.

While embodiments of the present invention are described in reference to an ONT, one skilled the art will readily recognize that the principles of the invention apply to both an ONT and an ONU or other termination configured to support embodiments as described herein.

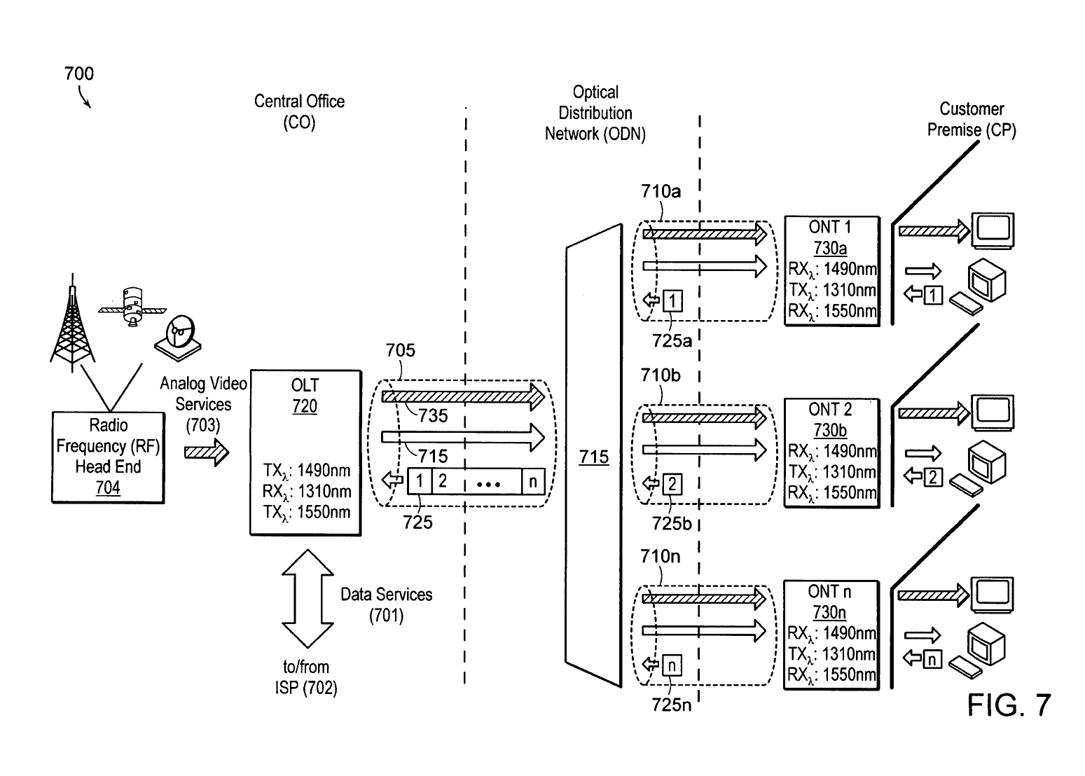

FIG. 7 illustrates an example PON 700 providing services over a shared fiber 705 and distribution fibers 710a . . . 710n. To provide services, such as data services 701 to and from an ISP 702 over the shared fiber 705 and distribution fibers 710a . . . 710n, downstream communications 715 and upstream communications 725a . . . 725n are multiplexed or otherwise combined by using different wavelengths for each of the communications directions, as is known in the art.

The downstream communications 715 use a first wavelength, for example, 1490 nanometers (nm), while the upstream communications 725a . . . 725n use a second wavelength, for example, 1310 nm. That is, services provided to customers over the downstream communications 715 are transmitted by an OLT 720 at 1490 nm and received by ONTs 730a . . . 730n at 1490 nm.

To add or to overlay an additional service, such as analog video services 703 from an radio frequency (RF) head end 704, over the shared fiber 705 and the distribution fibers 710a . . . 710n, an overlay 735 is assigned or otherwise uses a third wavelength. For example, the overlay 735 may use a wavelength of 1550 nm. That is, services provided to customers over the overlay 735 are transmitted by the OLT 720 at 1550 nm and received by the ONTs 730a . . . 730n at 1550 nm.

Because different wavelengths may be used to provide services over a shared fiber, a configuration for ensuring continuous video services may include a wavelength corresponding to the provided video services.

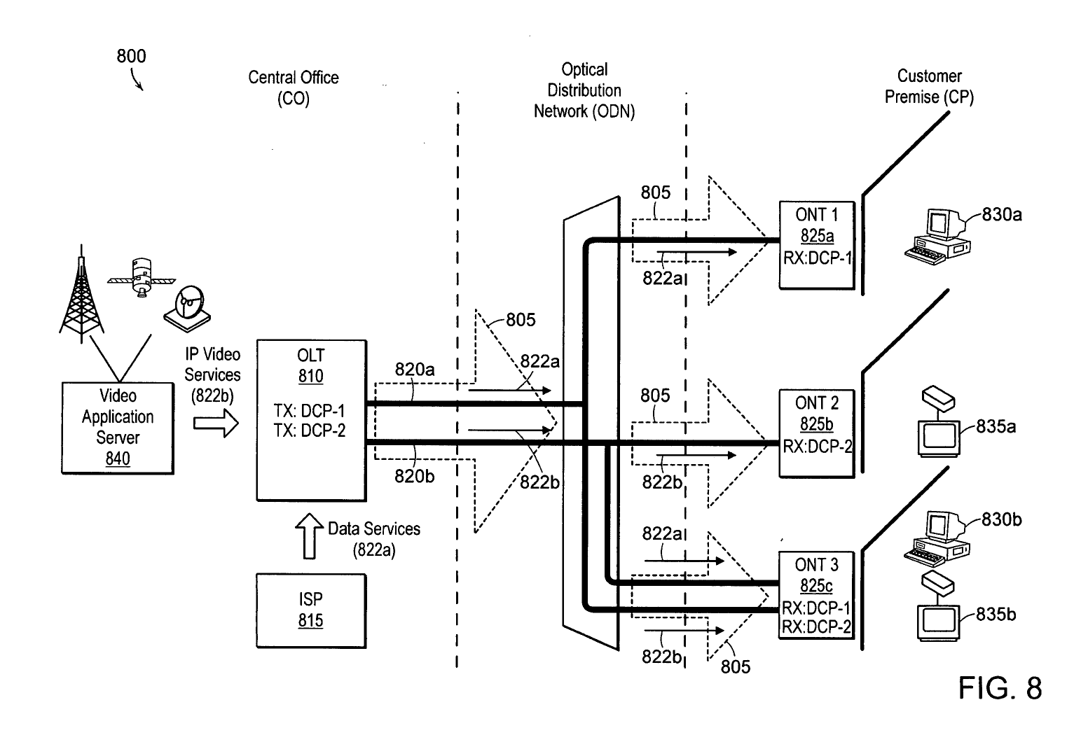

FIG. 8 illustrates an example passive optical network (PON) 800 providing services to customers over downstream communications 805 between an OLT 810 and ONTs 825a . . . 825c. Services, such as data services 822a and IP video services 822b are provided over the downstream communications 805 using one or more downstream communications paths 820a, 820b.

Each service 822a, 822b uses a different, respective, downstream communications path 820a, 820b to provide service to customers. For example, data services 822a are provided to customers over the downstream communications path 820a (DCP-1) for data services 822a. Data services 822a from an ISP 815 are transmitted by the OLT 810 over the downstream communication path 820a. In this example, the data services 822a from the ISP 815 are received by the ONTs 825a and 825b over the downstream communications path 820a for data services 822a. The data services 822a from the ISP 815 are then provided to computers 830a and 830b.

In another example, IP video services 822b are provided to customers over the downstream communications path 820b (DCP-2) for IP video services 822b. IP video services 822b from a video application server (or video services server) 840 are transmitted by the OLT 810 over the downstream communications path 820b for IP video services 822b. In this example, the IP video services 822b from the video application server 840 are received by the ONTs 825b and 825c over the downstream communications path 820b for IP video services 822b. The IP video services 822b are then provided to set-top boxes/televisions 835a and 835b.

At least one of the downstream communications paths 820a, 820b (e.g., the downstream communications path 820a for data services 822a) may be, for example, an asynchronous transport mode (ATM) virtual channel connection (VCC) or a Gigibit-capable passive optical network (G-PON) encapsulation mode (GEM) port, in accordance with International Telecommunication Union (ITU) specification G.984.3, “Gigibit-capable Passive Optical networks (G-PON): Transmission convergence layer specification,” section 5.3.

Because a downstream communications path may be used to provide services over downstream communications, a configuration for ensuring continuous video services may include the downstream communications path over which the video services are provided.

In contrast, some services, such as analog video services, are provided over a separate downstream communications (e.g., the overlay of FIG. 7) without having to specify paths in the communications themselves. As such, in the analog video world, a passive optical network (PON) element, such as an ONT, needs only to pass the entire analog radio frequency (RF) signal downstream towards a customer to provide analog services. In stark contrast, in the IP video world, the same PON element needs to be a much smarter and more complex device.

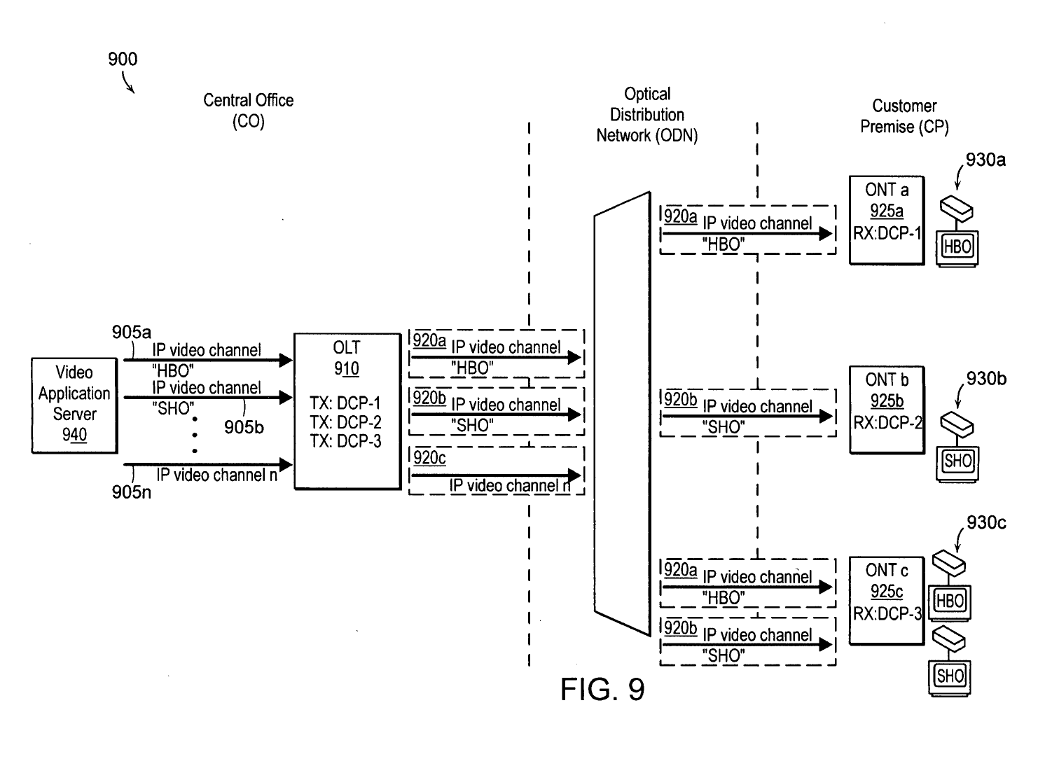

As described in greater detail below in reference to FIGS. 9-15, providing IP video services may require a PON element to maintain knowledge of specific IP video channels currently being viewed or previously viewed by a customer. Furthermore, the PON element may be required to monitor IP video channel change requests by the customer in order to provide IP video services.

FIG. 9 illustrates an example PON 900 providing IP video services to customers over downstream communications paths 920a . . . 920c. In this example, the downstream communications paths 920a . . . 920c are “unicast” (or one-to-one) in nature. That is, IP video services are provided to each customer over individual downstream communications paths.

For example, a first IP video service 905a (e.g. an IP video channel “HBO”) from a video application server (video services server) 940 is transmitted by an OLT 910 over a first downstream communications path 920a (DCP-1) to a first customer premise 930a. The first IP video service 905a from the video application server 940 is received by a first ONT 925a over the first downstream communications path 920a.

Similarly, a second IP video service 905b (e.g. IP video channel “SHO”) from the video application server 940 is transmitted by the OLT 910 over a second downstream communications path 920b (DCP-2) to a second customer premise 930b. The second IP video service 905b from the video application server 940 is received by a second ONT 925b over the second downstream communications path 920b.

It should be noted that each IP video service provided to a customer is provided over a downstream communications path particular to that IP video service, even if two or more IP video services provide the same IP video channel. For example, even though the IP video channel HBO is provided over the first downstream communications path 920a, to provide the same IP video channel to a third customer premise 930c, the IP video channel HBO is provided over a third downstream communications path 920c (DCP-3).

This type of provided IP video services is an example of video on demand (VOD).

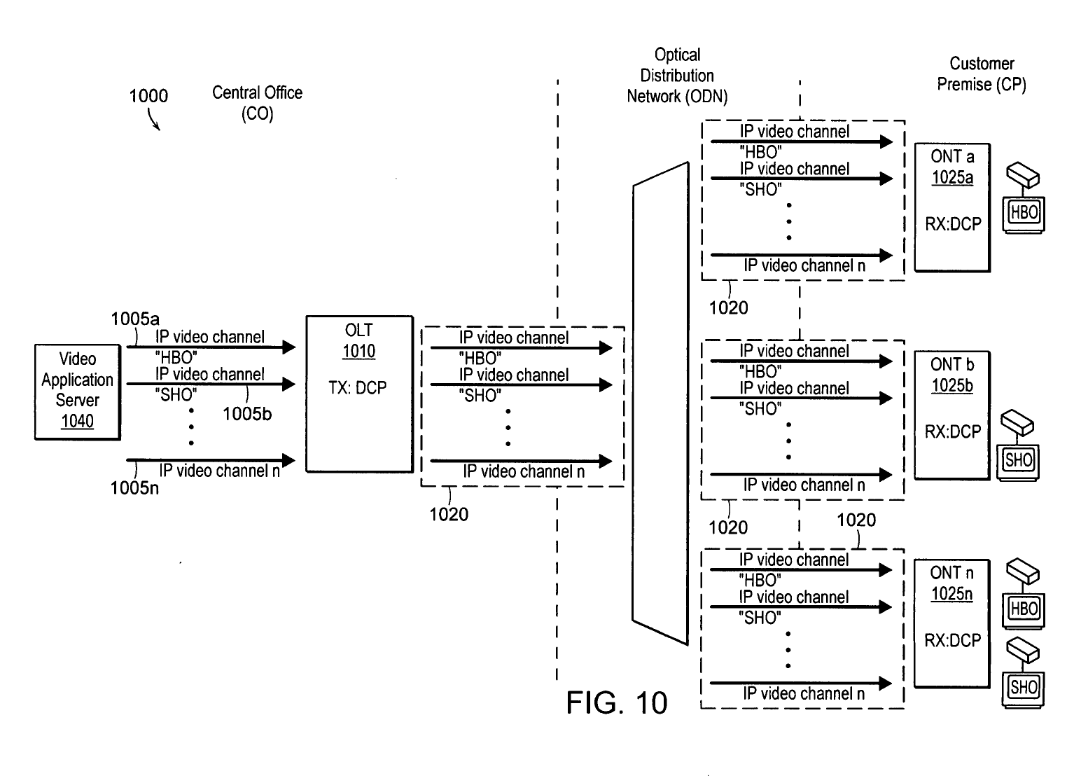

FIG. 10 illustrates an example PON 1000 providing IP video services to customers over a downstream communications path (DCP) 1020. In this example, the downstream communications path 1020 is “broadcast” (or one-to-all) in nature. That is, IP video services are provided to all customers over the downstream communications path 1020. For example, IP video services, such as IP video channel “HBO” 1005a, IP video channel “SHO” 1005b through IP video channel n 1005n from a video application server (or video services server) 1040, are transmitted by an OLT 1010 over the downstream communications path 1020. The IP video services from the video application server 1040 are received by ONTs 1025a . . . 1025n over the downstream communications path 1020. Since the downstream communications path 1020 is accessible to all the ONTs 1025a . . . 1025n, the downstream communications path 1020 is said to be “broadcast” in nature.

Moreover, IP video services provided over the downstream communications path 1020 (e.g., all IP video channels offered or subscribed to by the ONTs 1025a . . . 025n) are accessible by all the ONTs 1025a . . . 1025n. In this way, multiple IP video services or different IP video services may be offered over multiple downstream communications paths. For example, a first grouping of IP video channels A, B, and C are provided over a first downstream communications path, while a second grouping of IP video channels D, E, and F are provided over a second downstream communications path.

Because a particular video service may be provided over a particular downstream communications path, a configuration for ensuring continuous video services may include the particular downstream communications path over which the video service is provided.

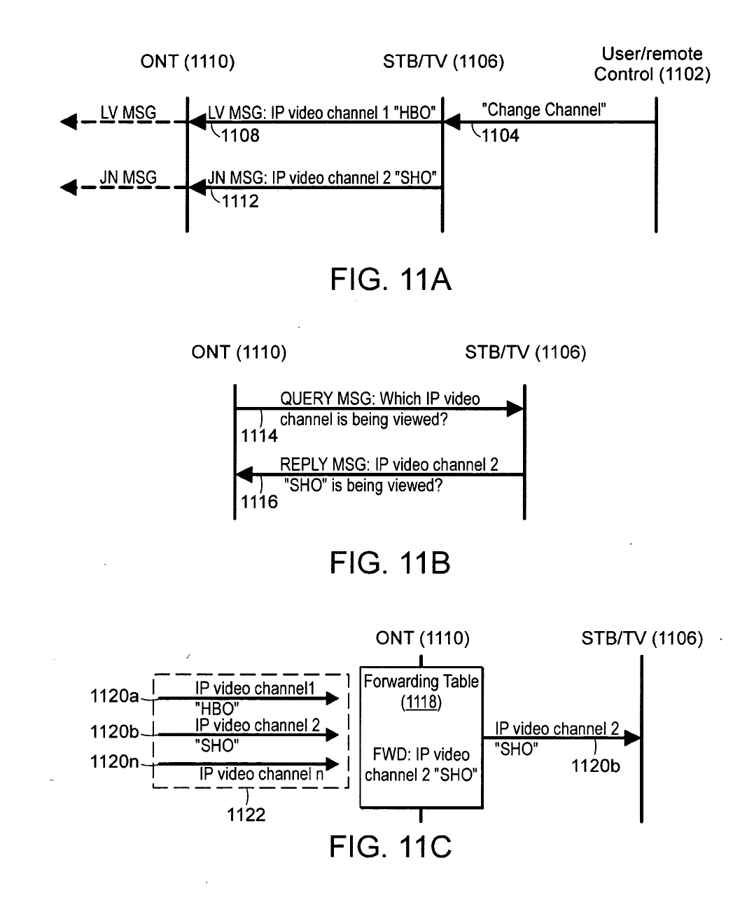

FIG. 11A is a signal diagram illustrating signals passed along example nodes of a PON resulting from a user 1102 changing an IP video channel or otherwise switching from a first IP video channel to a second IP video channel. The user 1102, typically via a remote control (not shown), issues a “change channel” request command 1104 to a set-top box 1106. The set-top box 1106 sends a “leave” signal or message 1108, identifying a first IP video channel from which to leave, to an ONT 1110, where the “leave” signal or message 1108 indicates that the set-top box 1106 no longer wants the (first) corresponding first IP video channel to be sent via downstream communications. The ONT 1110 processes the “leave” signal or message 1108. Alternatively, the ONT 1110 passes the “leave” signal or message 1108 upstream to, for example, a video application server (or video services server, not shown).

The set-top box 1106 sends a “join” signal or message 1112, identifying a second IP video channel to which to “join”, to the ONT 1110, where the “join” signal or message 1112 indicates that the set-top box 1106 wants the corresponding (second) IP video channel to be sent via downstream communications. Again, the ONT 1110 processes the “join” signal or message 1112 or alternatively passes the “join” signal or message 1112 upstream to, for example, a video application server (or video services server, not shown).

Whether the ONT 1110 processes or passes the “leave” message 1108 or “join” message 1112, in either instance, the ONT 1110 is aware of the messages. That is to say, the ONT 1110 is capable of “snooping” or otherwise monitoring messages sent upstream from the set-top box 1106.

By monitoring messages sent upstream from the set-top box 1106, from the “leave” message 1108 the ONT 1110 is aware of which IP video channel was viewed before the user 1102 changed IP video channels. Similarly, from the “join” message 1112, the ONT 1110 is aware of which IP video channel was viewed after the user 1102 changed IP video channels. In this way, a video service currently being viewed may be determined by monitoring “leave” and “join” messages used to request a change from a first video service to a second video service.

It is possible however, the ONT is unable to monitor or otherwise misses the most recent “leave” and “join” messages. For example, the user 1102 changes IP video channel while the ONT is rebooting. Thus, it may be more accurate to say a video service previously viewed rather than a video service currently being viewed is determined by monitoring “leave” and “join” messages. Accordingly, by monitoring “leave” and “join” messages, an at least one video service previously viewed may be determined and may be maintained to ensure continuous video services.

Alternatively, as illustrated in FIG. 11B, a video service previously viewed may be determined by querying the set-top box 1106. In this example, the set-top box 1106 is queried by the ONT 1110 with a query signal or message 1114. The query signal or message 1114 requests the video service currently being viewed be identified. In response, the set-top box 1106 sends a reply signal or message 1116 identifying the video service currently being viewed. In this way, the video service currently being viewed may be determined by sending the query message 1114. Accordingly, by sending a reply signal or message, an at least one video service previously viewed may be determined and may be maintained to ensure continuous video services.

Alternatively, as illustrated in FIG. 11C, a video service previously viewed may be determined by consulting a forwarding table 1118. The forwarding table 1118 may be said to act as a filter by forwarding certain video services to the set-top box 1106 and not forwarding other video services. For example, n number of IP video channels 1120a . . . 1120n are provided over a downstream communications path 1122 in the example of FIG. 11C. The forwarding table 1118 forwards the IP video channel 1120b, but not the IP video channels 1120a and 1120c . . . 1120n. In this way, the video service currently being viewed may be determined from which video service is forwarded and which video services are not. Accordingly, by consulting a forwarding table, at least one video service previously viewed may be determined and may be maintained to ensure continuous video services.

The “join”, “leave”, and query messages described above may in some embodiments be Internet Group Management Protocol (IGMP) messages, described in Internet Engineering Task Force (IETF) Request For Comments (RFC) 1112 (version 1), RFC 2236 (version 2), and RFC 3376 (version 3). Some embodiments may employ a “snooping” (or proxying) technique in accordance with IETF Internet-Draft draft-ietf-magma-snoop-12.txt entitled, “Considerations for IGMP and MLD Snooping Switches.”

In an IP video world, an end-user (or customer) uses IP video equipment capable of understanding how to offer or otherwise provide IP video services. One common protocol used by IP video equipment and other such network equipment to offer IP video services is the Internet Group Management Protocol (IGMP).

In the context of IGMP, there is an IGMP Client (e.g., the set-top box of FIG. 11) and at least one IGMP Host (e.g., the video application server of FIG. 8). For simplicity, in a typical IGMP (version 2) manner, the IGMP Client (or other IGMP-capable device) subscribes to a specific channel by sending an IGMP Multicast Membership Report message upstream to the IGMP Host to “join” a specific IP video channel or service. Similarly, if the end-user changes channels, the IGMP Client sends an IGMP Multicast Leave Group message upstream to the IGMP Host to “leave” a first IP video channel and an IGMP Multicast Membership Report message to “join” a second IP video channel.

Additionally, the IGMP client responds to an IGMP Group Membership Query message to allow, for example, a multicast router (e.g., an ONT or an OLT configuring to route multicast data) to determine if any IP video channels should be forwarded or otherwise communicated to the IGMP client.

One skilled in the art will readily recognize that monitoring “leave” and “join” messages, or sending a query message requesting at least one most recently viewed video service be identified, to maintain at least one most recently viewed video service is not intended to be limited to IGMP messages, but includes other types of messages. For example, IGMP version 3 messages may be used to maintain at least one most recently viewed video service.

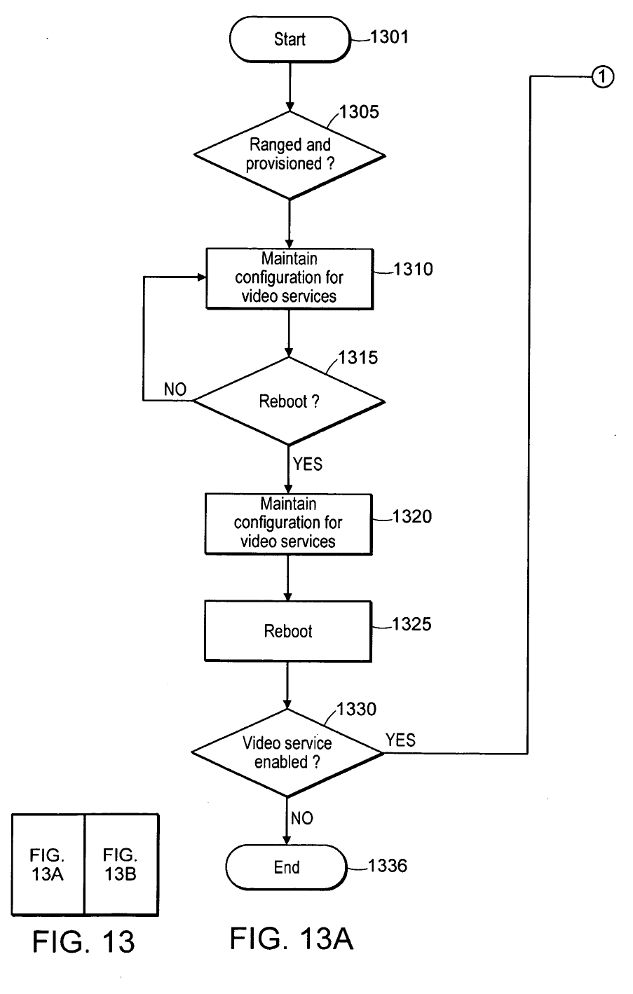

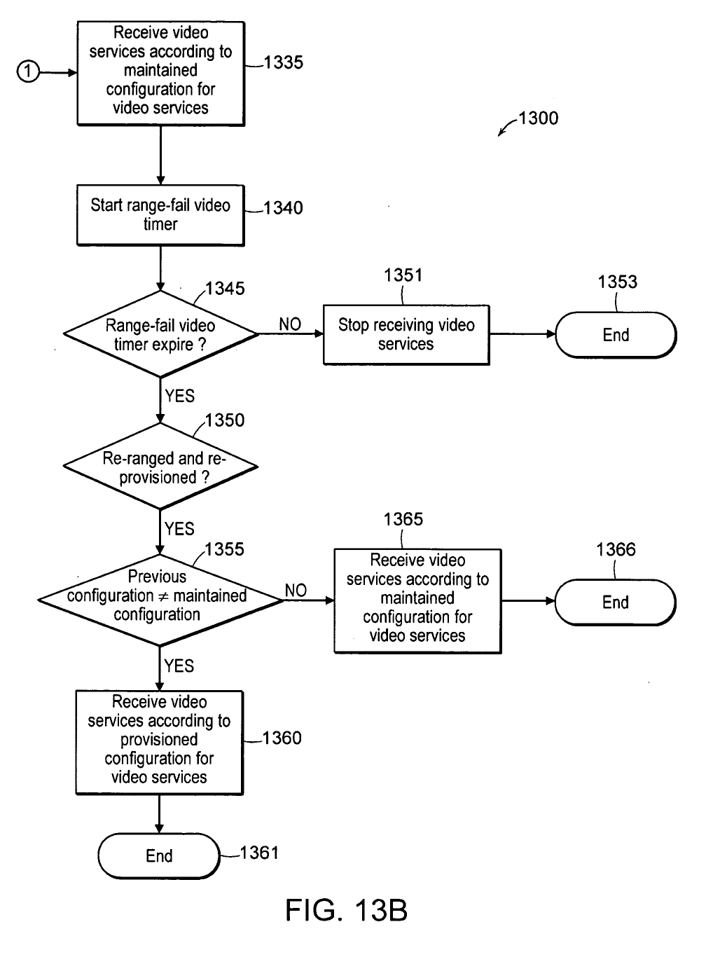

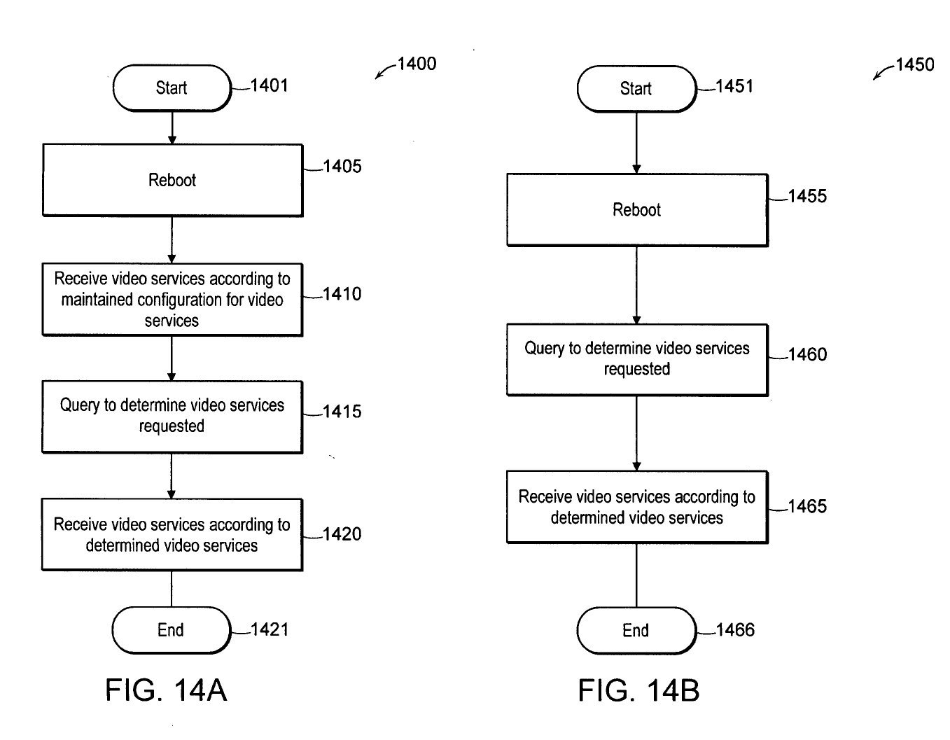

FIG. 12 is chart which provides an overview of events occurring at an OLT 1205, ONT 1210, and set-top box/television (STB/TV) 1215 at three different instances in time, 1201a, 1201b, and 1201c. The details of individual events are provided below in reference to FIGS. 13 and 14.

Continuing to refer to FIG. 12, in the first instance 1201a, at substantially about a time before the ONT 1210 is rebooted and re-ranged, at the OLT 1205, a configuration for IP video services is provisioned (1220). At the ONT 1210, the provisioned configuration for IP video services is maintained (1225). At the set-top box/television 1215, a first IP video channel, for example HOME BOX OFFICE (HBO), is being watched (1230).

Maintaining a configuration for IP video services at the ONT 1215 includes maintaining, for example, a state of receipt of video services, downstream communications path for delivering video services, list of allowable video services, at least one video service previously viewed, range-fail timer to ensure that video services are no longer provided in an event the ONT 1215 is not re-ranged within a certain amount of time, and any information necessary to access a downstream communications wavelength (e.g., the wavelength of 1490 nm used by the downstream communications 715 of FIG. 7).

In the second instance 1201b, at substantially about a time after the ONT 1210 is rebooted and waiting to be re-ranged, at the OLT 1205, a reboot command is issued (1235) to reboot the ONT 1210, for example, to upgrade the ONT 1210. At the ONT 1210, IP video services are received (1240) according to the maintained configuration for IP video services for an amount of time defined by a default value or other defined value. For example, IP video services are received (1240) during a period from a time the ONT 1210 is rebooted to a time the ONT 1210 is ranged and provisioned. In this way, at the set-top box/television 1215, the first IP video channel (HBO) may still be watched even though the ONT 1210 is not yet ranged and provisioned for upstream communications.

Alternatively, at the set-top box/television 1215, the first IP video channel (HBO) may be switched or otherwise changed and a second IP video channel, for example SHOWTIME (SHO) is being watched (1245).

In the third instance 1201c, at substantially about a time the ONT 1210 is rebooted and re-ranged, at the OLT 1205, a second configuration for IP video service is provisioned (1250). At the ONT 1210, the second configuration (i.e., the provisioned configuration) is given precedence (1255) over the maintained configuration for IP video services in an event the maintained configuration differs from the provisioned configuration. For example, an IP video channel previously allowed or available in the maintained configuration is no longer allowed in the provisioned configuration. In the example illustrated in FIG. 12, the previously allowed IP video channel SHO is no longer allowed. Consequently, at the set-top box/television 1215, the second IP video channel cannot be watched (1260).

FIG. 13 is a flowchart of an example process 1300 for ensuring continuous video service based on conditions in a PON. The process 1300 starts (1301). The process 1300 determines (1305) whether an ONT has been ranged and provisioned with, for example, a configuration for video services. If the process 1300 determines (1305) the ONT has been ranged and provisioned, the process 1300 maintains (1310) a configuration for video services.

The process 1300 maintains (1310) the configuration for video services by maintaining, for example, the following information: a state (or mode) of receipt of the video services, downstream communications path for delivering the video services, list of allowable video services, at least one video service previously viewed, range-fail timer to ensure that an ONT stops providing video services in an event the ONT is not re-ranged within a certain amount of time, and any information necessary to access a downstream communications wavelength. For example, the process 1300 maintains (1310) the configuration for video services by maintaining: an IP video service state (i.e., whether IP video services is enabled or disabled); VCC or GEM Port ID containing all of the IP video channels, allowable lineup of IP video channels; IP video channel current being viewed, and information necessary to access a downstream 1490 nm signal.

In another example, the process 1300 maintains (1310) the configuration for video services by maintaining, for example, substantially the same information as the previous example with the exception of the allowable lineup of IP video channels. In some instances, an ONT is configured with a pre-configured list of IP video channels to which a customer has access.

The process 1300 maintains (1310) the configuration for video services by storing the maintained configuration for video services internal to the ONT, for example, in FLASH or nonvolatile random access memory (NVRAM).

Continuing with FIG. 13, the process 1300 determines (1315) whether the ONT is to be rebooted, for example, whether a command has been issued to reboot the ONT or the ONT is being upgraded. The process 1300 maintains (1320) the configuration for video services as described above. The process 1300 reboots (1325) the ONT.

However, if the process 1300 determines (1315) the ONT is not to be rebooted (e.g., the ONT is operating normally), the process 1300 continues to maintain (1310) the configuration for video services. For example, the configuration for video services may be maintained (1310) on a periodic or scheduled basis. Alternatively, the configuration for video services may be maintained (1310) in response to an event (e.g., a loss of power) or is otherwise event driven.

The process 1300 determines (1330) whether video services are enabled. If the process 1300 determines (1330) video services are enabled, the process 1300 receives (1335) video services according to the maintained configuration for video services. However, if the process 1300 determines (1330) video services are not enabled the process 1300 ends (1336).

If video service are enabled (1330), the ONT receives (1335) video services according to a maintained configuration for video services. Thereafter, the process 1300 starts (1340) a range-fail video timer. The range-fail video timer is set for a default amount of time. For example, the default amount of time which is set can take into consideration the amount of time for a PON card (or other relevant cards/equipment in an OLT) to reboot plus the amount of time for the PON card to range all ONTs on a PON. Consider the following example. Assume it takes 1 minute for a PON card to reboot and another 2 minutes to re-range and provision all ONTs on a PON. In this example, it may be appropriate to set the range-fail video timer to 3-5 minutes. In this way, when the range-fail video timer expires, it may be assumed that the PON card had an opportunity to reboot, and the ONTs in the PON had an opportunity to be re-ranged and provisioned. In another example, the default amount of time which is set provides a sufficient amount of time for troubleshooting purposes. In yet another example, the default amount of time is set to a value determined by a customer.

The default amount of time set may be stored in the ONT, for example, in FLASH memory or nonvolatile random access memory (NVRAM). Additionally, the default amount of time set may also be updated, for example, locally by a technician or remotely by an element management system (EMS). The range-fail video timer may be any type of timing mechanism capable of measuring or providing information for measuring a given length of time, such as a counter or a monitoring device monitoring a clock.

The process 1300 determines (1345) whether the range-fail video timer has expired. If the process 1300 determines (1345) that the range-fail video timer has expired, the process 1300 stops (1351) receiving video services, and the process 1300 ends (1353). However, if the process 1300 determines (1345) that the range-fail video has not expired, the process 1300 determines (1350) whether the ONT has been re-ranged and re-provisioned with, for example, another configuration for video services.

If the process 1300 determines (1350) that the ONT has been re-ranged and re-provisioned, the process 1300 determines (1355) whether the provisioned configuration for video services differs from the maintained configuration for video services. If the process 1300 determines (1355) that the provisioned configuration for video services differs from the maintained configuration for video services, the process 1300 receives (1360) video services according to the provisioned configuration for video services. In this way, precedence or priority is given to a configuration for video services provisioned by a second PON element, such as an OLT, in an event the maintained configuration for video services differs from the configuration for video services provisioned by the second PON element. After receiving the video service (1360), the process 1300 ends (1361).

If, however, the process 1300 determines (1355) that provisioned configuration for video services is the same or is otherwise equal to the maintained configuration for video services, the process 1300 receives (1365) video services according to either the maintained configuration for video services or the provisioned configuration for video service, and then the process 1300 ends (1366).

As described above in reference to FIG. 11A, when an IP video channel is changed or is otherwise switched from a first IP video channel to a second IP video channel, an ONT is aware of “leave” and “join messages” indicating which IP video channels were viewed before and after a user changed IP video channels. In this way, a video service currently being viewed may be determined by monitoring “leave” and “join” messages used to request a change from a first video service to a second video service.

It is possible, however, that an IP video channel is changed or is otherwise switched from a first IP video channel to a second IP video channel from a time when an ONT reboots to a time when the ONT re-gains access to the provided IP video services. Until further notice, the ONT may still only have knowledge of the first IP video channel (e.g., from a maintained configuration) viewed prior to the ONT rebooting. In other words, the configuration for video services maintained by the ONT is stale and does not represent a current configuration for IP video services.

FIG. 14A illustrates an example process 1400 for maintaining at least one video service previously viewed while alleviating the problem of a stale maintained configuration for video services. The process 1400 starts (1401). The process 1400 reboots (1405). The process 1400 receives (1410) video services according to a maintained configuration for video services. The process 1400 queries (1415) to determine a video service requested. For example, an ONT may send a query message to a set-top box, as described above in reference to FIG. 1l B. The process 1400 receives (1420) video services according to the video services determined. The process 1400 ends (1421).

The following example illustrates maintaining at least one video service viewed in accordance with an embodiment of the present invention. The ONT reboots and forwards an IP video channel (or IP video stream) last known to the ONT. The ONT sends an IGMP membership query to a customer's set-top box or IGMP client to determine which IP video channel was last requested by the IGMP client. The ONT receives an IGMP membership report indicating which IP video channel was last requested and ensures that the last requested IP video channel is delivered to the IGMP client. As such, at least one video service previously viewed is maintained while the problem of a stale maintained configuration for video services is alleviated.

FIG. 14B illustrates an alternative process 1450 for maintaining at least one video service previously viewed while alleviating the problem of a stale maintained configuration for video services. The process 1450 starts (1451). The process 1400 reboots (1455). The process 1450 queries (1460) to determine a video service requested. For example, an ONT may send a query message to a set-top box, as described above in reference to FIG. 1l B. The process 1400 receives (1465) video services according to the video services determined. The process 1400 ends (1466).

The following example illustrates maintaining at least one video service previously viewed in accordance with an embodiment of the present invention. The ONT reboots, but, unlike the previous example, the ONT does not forward an IP video channel (or IP video stream) known to the ONT. The ONT sends an IGMP Group Membership Query message to the customer's set-top box or IGMP client to determine which IP video channel was last requested by the IGMP client. The ONT receives IGMP Multicast Membership Report message indicating which IP video channel was last requested and ensures that the last requested IP video channel is delivered to the IGMP client. As such, at least one video service previously viewed is maintained while the problem of a stale maintained configuration for video services is alleviated.

One difference, for example, between the process 1400 (illustrated in FIG. 14A) and the alternative process 1450 (illustrated in FIG. 14B) is an amount of time taken to provide a last requested IP video channel to a customer (i.e., the IP video channel actually being delivered to the customer). In some instances, for example, when a reboot occurs early in the morning or late at night when the customer is not likely to be changing channel or otherwise channel “surfing,” maintaining at least one video service previously viewed according to the process 1400 illustrated in FIG. 14A may be preferable. In contrast, when a reboot occurs in the middle of the day when the customer is likely to be channel “surfing”, maintaining at least one video service previously viewed according to the process 1450 illustrated in FIG. 14B may instead be preferable.

In contrast to the embodiments described in reference to FIGS. 14A and 14B, other embodiments of the present invention contemplate alternative behaviors. In particular, several embodiments consider how to handle a change from a first IP video service to a second IP video service when an ONT is not yet re-ranged. Recall, while an ONT may not yet be ranged and provisioned for upstream communications with an OLT (i.e., messages or data cannot be sent from the ONT to the OLT), downstream communications with the ONT may still be possible and services may still be provided over a downstream communications path.

In one embodiment, messages or signals identifying or otherwise indicating a change from a first IP video service to a second IP video service (e.g., the “leave” message 1108 and the “join” message 1112 of FIG. 11A) are discarded until an ONT is re-ranged. At a minimum, however, the embodiment allows the first IP video service to continue to be provided (and thus viewed by a customer) until the ONT is re-ranged.

In another embodiment, a second IP video service is provided according to messages or signals identifying a change from a first IP video service to the second IP video service. If, however, the second IP video service is not presently being provided on a downstream communications path for IP video services (i.e., it is not available on a PON), the first IP video service is not changed to the second IP video service. The first IP video service is changed to the second IP video service when the second IP video service becomes available on the PON, e.g., when another ONT, which has been ranged, requests the second IP video service or until the ONT is re-ranged (and thus upstream communications with the OLT are possible) and requests the second IP video service for itself.

Another alternative includes an ONT maintaining knowledge of messages or signals identifying a change from a first IP video service to a second IP video service while the ONT is not yet re-ranged. Once re-ranged and upstream communications with an OLT are possible, such messages are then communicated to the OLT.

Yet another alternative includes auditing an ONT (e.g., using the query message described in reference to FIG. 11B) once the ONT is re-ranged. The ONT communicates with an OLT (e.g., using the “join” message described in reference to FIG. 11A) an IP video service currently being provided to a customer once upstream communications with the OLT are possible.

Under normal operating conditions, when an OLT (or a PON card in the OLT) reboots all ONTs on the PON are re-ranged. The ONTs are said to have “lost” ranging with an OLT. Until an ONT is re-ranged, upstream communications with the OLT is not possible. Downstream communications with the ONT, on the other hand, is possible. Consequently, the OLT may setup or otherwise establish a downstream communications path for IP video services. In this way, even before the ONT is ranged with the OLT, the ONT has access to the downstream communications path for IP video services and may begin providing IP video services to a customer. However, the ONT may or may not be aware or otherwise know whether the downstream communications path for IP video services is established and/or whether IP video services are available to be provided to the customer

Accordingly, in one embodiment of the present invention, in an event an ONT “loses” ranging with an OLT, for example, when the OLT reboots or when there is temporary loss of signal condition between the ONT and the OLT, a downstream communications path for IP video services (e.g., a VCC or a GEM Port ID) is monitored for available IP video services. The downstream communications path may be monitored for an amount of time defined by a default value. For example, the downstream communications path may be monitored for available IP video services starting from when an ONT loses ranging with an OLT until a range-fail video timer (described in reference to FIG. 13) expires.

At the expiration of such an amount of time, if the ONT has not been re-ranged, the ONT may stop monitoring the downstream communications path for IP video services for available IP video services. In such an instance, it may be assumed that there are problems in the ability of the OLT to deliver IP video services on the PON. Furthermore, since the ONT has not been re-ranged, it may also be assumed that there are problems with this specific ONT in general.

In this way, a downstream communications path for IP video services is monitored for available video services in an event an ONT loses ranging with an OLT.

In another embodiment of the present invention, prior to an OLT rebooting (and thus prior to ONTs losing ranging with the OLT) the OLT sends a message to the ONTs indicating that a controlled action in the OLT has occurred or is substantially about to occur. The ONTs may therefore continue monitoring a downstream communications path for IP video services (e.g., a VCC or GEM Port ID) for available IP video services.

For example, the OLT may send an upgrade/reboot indication message (URIM) to all the ONTs on a PON prior to rebooting. ONTs receiving such a message may or may not decide to continue monitoring the downstream communications path for IP video services for available video services for an amount of time defined by a default value. ONTs not receiving such a message or receiving some other message, however, may perform other actions, e.g., stop monitoring the downstream communications for IP video services for available IP video services.

In yet another embodiment of the present invention, when an OLT (or a PON card in the OLT) successfully boots up following a reboot, the OLT may send a general broadcast message to all ONTs on the PON that IP video services are available over a downstream communications path for IP video services. Accordingly, as long as the ONTs have knowledge of and have access to the downstream communications path (e.g., by maintaining a configuration described in the reference to FIG. 12) and the ONTs receive the general broadcast message over the downstream communications path of IP video services, the ONTs are aware that IP video services are available over such a path. In this way, a downstream communications path for IP video services is monitored for a message indicating video services are available, in an event an ONT loses ranging with an OLT.

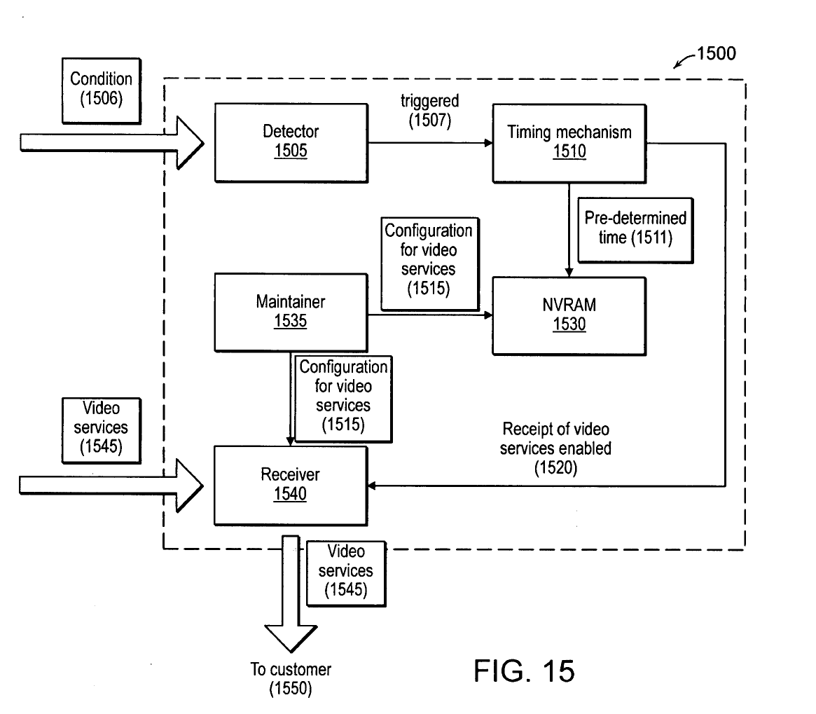

FIG. 15 illustrates an example passive optical network (PON) element 1500 for ensuring continuous receipt of video services. The PON element 1500 includes a detector 1505 to detect a condition 1506 indicating a change of state in receipt of video services. Connected to the detector 1505 is a timing mechanism 1510 to enable video services for a predetermined (or dynamic) amount of time 1511.

In an event the detector 1505 detects the condition 1506 indicating a change of state in receipt of video services, such as a loss of ranging or a loss of signal, the timing mechanism 1510 is triggered (represented by reference number 1507). The timing mechanism 1510 enables receipt of video services (represented by reference number 1520). The PON element 1500 enables (1520) receipt of video services for the predetermined amount of time 1511. In one embodiment of the present invention, the timing mechanism 1510 disables receipt of video services when the predetermined amount of time 1511 expires. It should be understood that video services may also be disabled after a predetermined amount of time by disabling transmission of video services towards a customer or subscriber.

The timing mechanism 1510 may be connected to a nonvolatile random access memory (NVRAM) 1530 or FLASH. The NVRAM 1530 stores the predetermined amount of time 1511. While the predetermined amount of time 1511 may be stored internally in (or “internal to”) the PON element 1500, the predetermined amount of time 1511 may be changed by a remote or external source (not shown).

The PON element 1500 may also include a maintainer 1535 to maintain a configuration for video services 1515 in a manner described in reference to FIG. 12. The NVRAM 1530 may be connected to the maintainer 1535 to maintain or otherwise store the maintained configuration for video services 1515.

The PON element 1500 may also include a receiver 1540 to receive video services 1545 according to the maintained configuration for video services 1515. The timing mechanism 1510 may be connected to the receiver 1540. In this way, receipt of the video services 1545 is enabled for the predetermined amount of time 1511, and the video services 1545 are received according to the maintained configuration for video services 1515. The PON element 1500 provides the video services 1545 to a customer (or subscriber) 1550. In this way, the PON element 1500 controls and monitors the receipt and transmission of the video services 1545 to the customer 1550.

One or more of the above elements may be implemented in a microprocessor, for example, the microprocessor of FIG. 2. Alternatively, one or more of the above elements may be implemented in software written to be executed by the microprocessor. One skilled in the art will really recognize that where the above elements are implemented is not of significance, but rather what functions are performed by the above elements are of significance.

To summarize the above, when an optical network terminal (ONT) is rebooted, for example, after being upgraded, the ONT may be not be ranged and provisioned for some time. This may disrupt services, such as video services provided to a customer. To ensure continuous receipt of video services based on certain conditions in a passive optical network (PON), the ONT detects a condition indicating a change of states in receipt of video services, starts a timing mechanism having a default value stored in the ONT, and enables receipt of video services at the ONT for an amount of time defined by the default value. Receipt of video services is enabled by maintaining a configuration for video services previously provisioned and re-provisioning the ONT with the maintained configuration. In this way, disruption to video services is reduced.

In addition to the above and described below in reference to FIGS. 16-20, receipt of video services at a PON element may be enabled for an amount of time defined by a default value by: (i) maintaining at a second PON element a configuration for video services for the amount of time defined by the default value and (ii) sending video services to the PON element according to the maintained configuration for video services for the amount of time defined by the default value.

FIG. 16, is an example embodiment in which, in a PON 1600, an OLT 1610 maintains a configuration for video services and sends video services 1605a and 1605b, according to the maintained configuration for video services to ONTs 1625a and 1625b to ensure receipt of the video services 1605a,b at the ONTs 1625a,b for an amount of time defined by a default value.

The OLT 1610 sends the video services 1605a,b through downstream communications paths 1620a and 1620b. In this example, each of the downstream communications paths 1620a,b is dedicated to an individual ONT (previously described in reference to FIG. 9). That is, the first downstream communications path (DSC-1) 1620a is dedicated to the first ONT 1625a, and the second downstream communications path (DSC-2) 1620b is dedicated to the second ONT 1625b. Alternatively, the video services 1605a,b may be provided over a downstream communications path shared by all the ONTs 1625a,b (previously described in reference to FIG. 10).

In this example, the OLT 1610 sends the video services 1605b to the second ONT 1625b even though the second ONT 1625b is “un-ranged” and not capable of upstream communications (denoted by dashed lines 1626). That is, despite the OLT 1610 being aware that the second ONT 1625b is “temporarily offline,” the OLT 1610 still sends the video services 1605b to the second ONT 1625b. In this way, the OLT 1610 enables receipt of the video services 1605b at the second ONT 1625b in an event the second ONT 1625b is temporarily offline.

Briefly, as is known in the art, an ONT may support more than one set-top box (STB); for example, a single ONT per home provides video services, such as IP video channels, to a first STB located in the living room of the home and a second STB located in the master bedroom of the home. In this way the IP video channel HOME BOX OFFICE (HBO) may be viewed at the first STB while the IP video channel SHOWTIME (SHO) is viewed at the second STB. Furthermore, one or more video services may be viewed at a single STB, for example, picture-in-picture IP video channels HBO and ENTERTAINMENT AND SPORTS PROGRAMMING NETWORK (ESPN) at the first STB. For the sake of convenience and for purposes of describing example embodiments of the invention, the above description is referred to either as video services being viewed at an ONT, STB or an ONT/STB.

Continuing to refer to FIG. 16, in a typical video services manner (e.g., per the Internet Group Management Protocol (IGMP) described in reference to FIGS. 11A-11C), set top boxes (STBs) 1630a and 1630b, and/or the ONTs 1625a,b are queried by a video application server (or video services server) 1640 for video services viewed at the STBs 1630a,b. In particular, queries 1606a and 1606b, query which video services are being viewed at the STBs 1630a,b (i.e., a “general” query) or, alternatively, whether specific video services are being viewed at the STBs 1630a,b (i.e., a “specific” query). One skilled in the art will readily recognize that embodiments of the present invention contemplate both general and specify query messages.

In response to the query 1606a,b, responses 1607a and 1607b, are sent to the video application server 1640. The responses 1607a,b indicate to the video application server 1640 which video services 1605a,b are being viewed at the STBs 1630a,b. As such, the responses 1607a,b indicate a “status quo” condition to the video application server 1640 that receipt of the video services 1605a,b are enabled at the STBs 1630a,b and that the video services 1605a,b should continue to be sent towards the STBs 1630a,b.

In this example, the response 1607a from the first ONT 1625a indicates to the video application server 1640 that the video services 1605a, namely, IP video channel ESPN is being viewed at the STB 1630a. That is, receipt of the IP video channel ESPN 1605a at the first ONT 1625a is enabled.

In contrast, the second ONT 1625b does not respond to the query 1606b. For example, the second ONT 1625b did not receive the query 1606b or is unable to send (denoted by the dashed lines 1626) the response 1607b. Such is the case when the second ONT 1625b reboots (e.g., after an upgrade) or experiences an ONT Loss of Physical Layer-Loss of Signal (ONT LOPL-LOS) condition (described in reference to FIG. 2).

Instead, the OLT 1610 maintains the configuration for video services by responding to the query 1606b on behalf of the second ONT 1625b, indicating that the video services 1605b should continue to be sent towards the STB 1630b. In this way the OLT 1610 indicates a status quo condition to the video application server 1640 on behalf of the second ONT 1625b. Moreover, receipt of the video services 1605b, namely, IP video channel HOME SHOPPING NETWORK (HSN) at the second ONT 1625b is enabled despite the second ONT 1625b itself not being able to respond.

Because an ONT and/or STB (for the sake convenience and readability, “ONT/STB”) responds to a query from a video application server typically, it may be said that an OLT performs an “ONT/STB proxy function” for the ONT/STB towards the video application server in an event the ONT/STB is not able to respond to the query. The OLT continues to perform the ONT/STB proxy function, in some instances, until the ONT is re-ranged or otherwise re-activated. Alternatively, the OLT performs the ONT/STB proxy function for an amount of time defined by a default or configurable value.

To perform such a proxy function for a particular ONT/STB, an OLT is at least aware of video services being viewed or otherwise being provided to a particular ONT/STB. As such, a configuration for video services as maintained by the OLT includes at least video services being viewed at the ONT/STB. One of ordinary skill in the art will readily recognize that the maintained configuration may include additional information.

For example, a configuration maintained at an OLT may include an IP address of a particular ONT/STB or customer information associated with the particular ONT/STB, so that a status quo condition may be indicated to a video application server.

In another example, a configuration maintained at an OLT may include a particular downstream communications path over which the video service is provided (e.g., an asynchronous transport mode (ATM) virtual channel connection (VCC) or a Gigibit-capable passive optical network (G-PON) encapsulation mode (GEM) port identifier) so that the OLT may send video services to the ONT/STB.

In yet another example, a configuration maintained at an OLT may be substantially similar to a configuration maintained at an ONT described previously in reference to FIGS. 7-10. For example, both the configuration maintained at the OLT and the configuration maintained at the ONT include: a state of receipt of video services, downstream communications path for delivering video services, list of allowable video services, at least one video service previously viewed, range-fail timer to ensure that video services are no longer provided in an event the ONT is not re-ranged within a certain amount of time, and any information necessary to access a downstream communications wavelength (e.g., the wavelength of 1490 nanometer used by the downstream communications 715 of FIG. 7).

A configuration maintained at an OLT may be maintained on a constant or continual basis by the OLT. Alternatively, the maintained configuration may be maintained on an “as-needed” basis. For example, prior to an ONT rebooting, the OLT is notified by either the ONT or a STB of at least video services being viewed at the ONT/STB (described below in greater detail). In this way, memory requirements, such as size and type, of the ONT may vary depending on whether the ONT maintains the configuration for video services on a continual or on an as-needed basis.

The OLT 1610 maintains the configuration for video services and sends video services according to the maintained configuration for video services for a duration specified in a timing mechanism (of a timer). Described in reference to FIG. 4, the duration specified by the timing mechanism may be an amount of time, for example, sufficient for troubleshooting purposes, determined or otherwise configured by a customer or to allow the ONTs 1625a,b to reboot.

In one convenient embodiment, an OLT stops sending video services to an ONT in an event the ONT is un-ranged after an amount of time defined by a default value (or a configurable value). Bandwidth once used for providing video services to the un-ranged ONT is now made available for other use, e.g., providing video services to another ONT. Additionally, video services may, in some cases, not be provided without a fee for an extended period of time.

In one convenient embodiment, an OLT stops maintaining a configuration for video services in an event the ONT is un-ranged after an amount of time defined by a default value. For example, the OLT stop performs an ONT/STB proxy function for an ONT/STB in an event the ONT remains un-ranged after expiration of a timer.

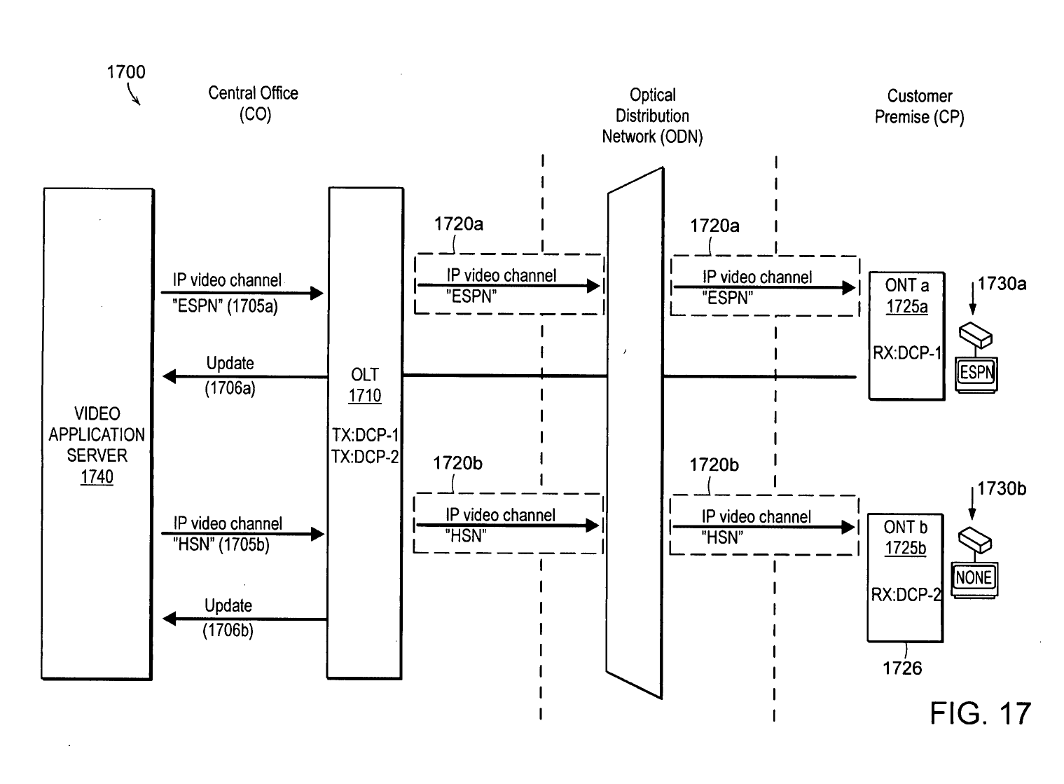

FIG. 17 is an example embodiment, in which, in a PON 1700, an OLT 1710 maintains a configuration for video services and sends video services 1705a and 1705b to ONTs 1725a and 1725b, to ensure receipt of the video services 1705a,b at the ONTs 1725a,b for an amount of time defined by a default value. The OLT 1710 sends the video services 1705a.b through downstream communications paths 1720a and 1720b. The OLT 1710 maintains the configuration for video services and sends video services according to the maintained configuration for a duration specified in a timer.

Set top boxes (STBs) 1730a and 1730b (and/or the ONTs 1725a,b), in contrast to the STB 1630 of FIG. 16, send updates 1706a and 1706b, to a video application server (or video services server) 1740. The updates 1706a,b, like the responses 1607a,b of FIG. 16, indicate a “status quo” condition to the video application server 1740 that receipt of the video services 1705a,b are enabled at the STBs 1730a,b and that the video services 1705a,b should continue to be sent towards the STBs 1730a,b. The updates 1706a,b include at least which the video services 1705a,b are being viewed at the STBs 1730a,b.

However, unlike the responses 1607a,b, the updates 1706a,b are not sent in response to the video application server 1740, e.g., in response to the queries 1606a,b of FIG. 16. Instead, the updates 1706a,b are sent the video application server 1740, for example, periodically or in an event there is a change at the STBs 1730a,b and/or the ONTs 1725a,b.

In this example, the update 1706a from the first ONT 1725a indicates to the video application server 1740 that the video services 1705a, namely, IP video channel ESPN is being viewed at the STB 1730a. That is, receipt of the IP video channel ESPN 1705a at the first ONT 1725a is enabled.

In contrast, the second ONT 1725b does not send the update 1706b because the second ONT 1725b, for example, the second ONT 1625b has not been ranged and is unable to send (denoted by dashed lines 1726) the update 1706b upstream towards the video application server 1740 (i.e., no upstream communications). Instead, the OLT 1610 maintains the configuration for video services by providing the update 1706b on behalf of the second ONT 1725b, indicating that the video services 1705b should continue to be sent towards the STB 1730b. In this way, the OLT 1710 indicates a status quo condition to the video application server 1740 on behalf of the second ONT 1725b. Moreover, receipt of the video services 1705b, namely, IP video channel HSN at the second ONT 1725b is enabled despite the second ONT 1725b itself not being able to provide an update.

Similar to responding to queries from a video application server (described above in reference to FIG. 16), typically, an ONT/STB provides updates to a video application server. As such, it may also be said that an OLT performs an “ONT/STB proxy function” for the ONT/STB towards the video application server in an event the ONT/STB is not able to provide updates. The OLT continues to perform the ONT/STB proxy function, in some instances, until the ONT is re-ranged or otherwise re-activated. Alternatively, the OLT performs the ONT/STB proxy function for an amount of time defined by a default value.

Also similar to responding to queries from a video application server (described above in reference to FIG. 16), to perform such a proxy function for a particular ONT/STB, an OLT is aware of video services being viewed or otherwise being provided to a particular ONT/STB. In some instances, for example, prior to an ONT rebooting, an OLT is notified by either the ONT or a STB of video services being viewed at the ONT/STB.

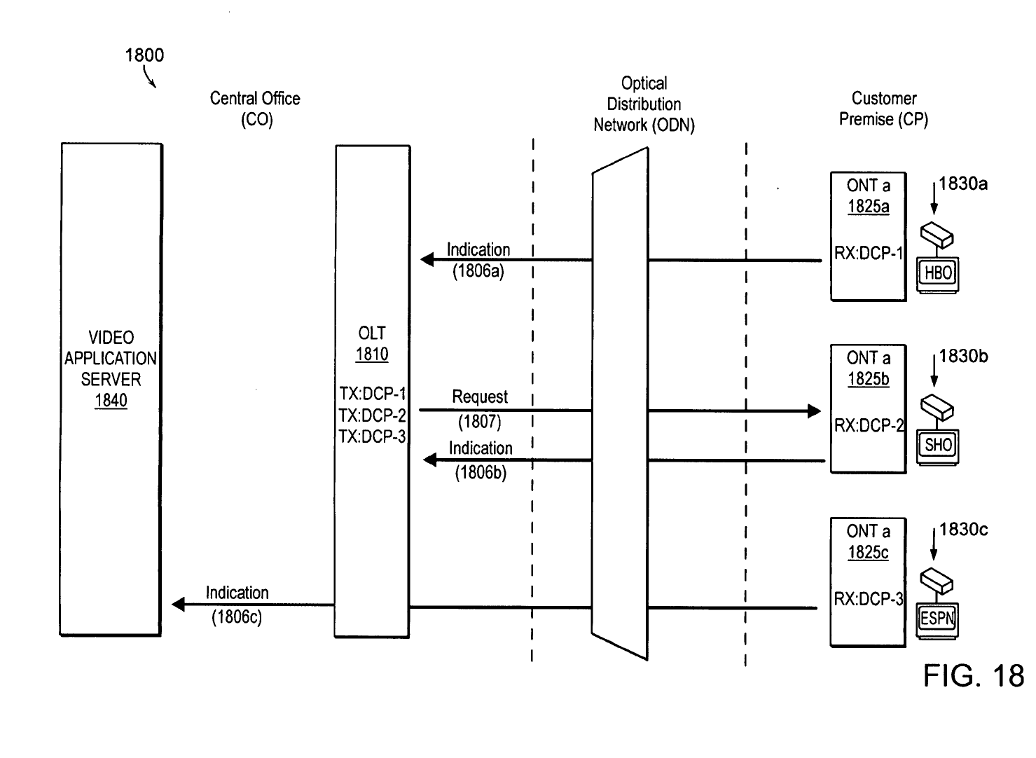

FIG. 18 is a network diagram that illustrates, in a PON 1800, an OLT 1810 receives at least indications 1806a, 1806b, and 1806c, of video services being viewed at ONTs 1825a, 1825b, and 1825c. For example, the OLT 1810 receives the indication 1806a indicating that the IP video channel HBO is being viewed at the ONT 1825a.

In some instances, the indications 1806a-c is used by the OLT 1810 to perform an ONT/STB proxy function, such as responding to video service queries from a video application server (or a video services server) 1840 (previously described in reference to FIGS. 16 and 17). In other instances, however, the indication 1806 is not necessary for the OLT 1810 to perform the ONT/STB proxy function (described below). As such, it should be readily apparent that the OLT 1810 may receive other information in addition to or in lieu of the indications 1806a-c. For example, to perform the ONT/STB proxy function, the OLT 1810 receives the indications 1806a-c and access information needed to enable receipt of video services at the ONTs 1825a-c.

In a convenient embodiment, the OLT 1810 also receives a configuration for video services as maintained by the ONTs 1825a-c as described above in reference to FIGS. 7-10. For example, the OLT receives: a state of receipt of video services, downstream communications path for delivering video services, list of allowable video services, at least one video service previously viewed, range-fail timer to ensure that video services are no longer provided in an event the ONT is not re-ranged within a certain amount of time, and any information necessary to access a downstream communications wavelength (e.g., the wavelength of 1490 nanometer used by the downstream communications 715 of FIG. 7).

From the above example, it should be apparent that a configuration for video services as maintained by the OLT 1810 (described above in reference to FIG. 16) and the configuration for video services as maintained by the ONTs 1825a-c are not necessarily the same. Moreover, the OLT 1810 does not need to receive the configuration for video services as maintained by the ONTs 1825a-c to maintain at the OLT 1810 a configuration for video services. For example, while the ONTs 1825a-c understands and requires information to access a downstream communications wavelength, the video services server 1840 does not. As such, to perform an ONT/STB proxy function, such as responding to video service queries from the video services server 1840, the OLT 1810 does not need to receive such information.

Continuing to refer to FIG. 18, in one example embodiment illustrated in FIG. 18, the OLT 1810 receives the indication 1806a from the ONT 1825a periodically (i.e., automatic) or in an event there is a change in video services at the ONT 1825a (i.e., event-driven).

In another example embodiment also illustrated in FIG. 18, the OLT 1810 receives the indication 1806b in response to a request 1807 from the OLT 1810. The request 1807 may be directed or otherwise addressed to an individual ONT (e.g., the ONT 1825b) or may be directed to all ONTs (e.g., the ONTs 1825a-c). In this way, an OLT may request once (i.e., broadcast a request), but receive indications from more than one ONT in response. For example, in response to the request 1807, the OLT 1810 receives the indications 1806a and 1806b from the ONTs 1825b and 1825b, respectively.

Similar to receiving the indications 1806a in the previous example embodiment, in another embodiment, the OLT 1810 may request for the indication 1806b periodically or in an event there is a change in video services at the ONT 1825b. However, unlike the previous example embodiment, in this embodiment the OLT 1810 requests the indication 1806b in addition to receiving the indication 1806b. Therefore, it may be said that in this embodiment, the OLT 1810 receives the indication 1806b actively as contrasted with passively.

In both of the previous example embodiments, the OLT 1810 is the intended recipient of the indications 1806a,b of video services being viewed at the ONTs 1825a,b. That is, the indications 1806a,b is directed or otherwise addressed to the OLT 1810.

In yet another example embodiment illustrated in FIG. 18, the OLT 1810 receives the indication 1806c but is not the intended recipient of the indication 1806c. As described in reference to FIG. 11A, video services being viewed at a PON element, such as an ONT, may be determined by monitoring messages or signals “joining” or “leaving” IP video channels. These messages are intended for and are directed to a video services server. As such, in this example embodiment, the OLT 1810 receives the indication 1806c by monitoring for messages not intended for the OLT 1810 itself, but intended for the video application server 1840.

In some instances, the above example embodiment may be preferred because it does not require directing an indication of video services being viewed at an ONT to an OLT. Instead, the indication may be gleaned or otherwise derived from existing messages or signals (described in reference to FIG. 11A). Consequently, this convenient embodiment reduces software/hardware overhead at an ONT, avoids adding complexity to an ONT, and conserves bandwidth, just to name a few conveniences. This embodiment does, however, require an OLT to understand these existing messages or signals; therefore, adding software/hardware overhead and complexity to the OLT.

One of ordinary skill in the art will readily recognize that some example embodiments of the invention contemplate an OLT receiving indications of video services being viewed at an ONT both directed to the OLT and directed to a PON element other than the OLT. Additionally, one of ordinary skill in the art will readily recognize that an OLT receiving an indication, in accordance with example embodiments of the invention may also include the OLT acknowledging that it received the indication and/or that the indication is uncorrupted.

The above example embodiments are contrasted with example embodiments described in reference to FIGS. 16 and 17. Unlike the embodiments of FIG. 18, to enable receipt of video services at an ONT, it is not necessary for the embodiments of FIGS. 16 and 17 to receive an indication of video services being viewed at the ONT. Rather, maintaining and sending video services as described in reference to FIGS. 16 and 17 alone are sufficient to enable receipt of video services at the ONT.

In one convenient embodiment, receipt of a preset or otherwise “fixed” video service at an ONT is enabled by an OLT maintaining and sending the preset video services as described in reference to FIGS. 16 and 17. To illustrate, consider the following example.

An ONT is upgraded with new software and reboots. While the ONT reboots, receipt of a service provider's IP video channel or “service channel” is enabled at the ONT. The service channel may provide, for example, service information, such as information regarding new features of the upgrade, alerts, etc.

The OLT enables receipt of the service channel by maintaining and sending the service channel as described in reference to FIGS. 16 and 17. Moreover, receipt of the service channel is enabled at the ONT regardless of video services being viewed at the ONT before the upgrade and reboot (as contrasted with example embodiments of FIG. 18). In this way, in this example, a service provider is able to provide service information to its customer.

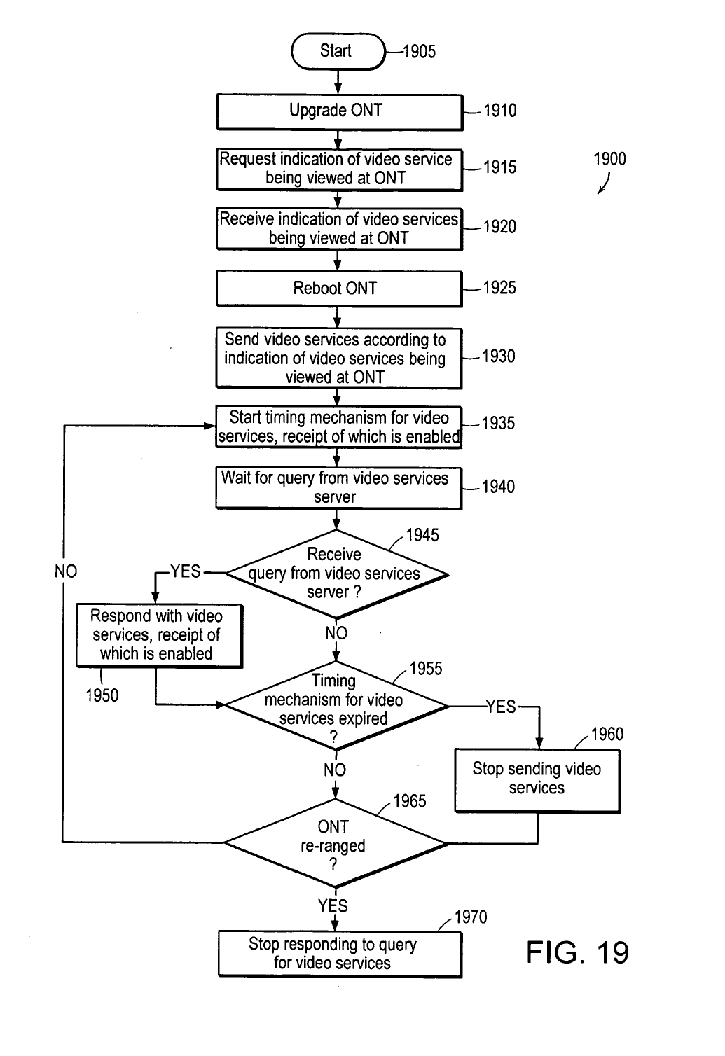

FIG. 19 is a flow diagram of, an example process 1900 that enables receipt of video services at a PON element, such as an ONT, for an amount of time defined by a default value. The process 1900 starts (1905). The process 1900 upgrades (1910) the ONT, for example, by sending an upgrade to the ONT. In upgrading the ONT, the process 1900 requests (1915) an indication of video services being viewed at the ONT. For example, the requested indication may be IP video channel information, such as the address of the IP video channel.

The process 1900 receives (1920) the indication of video services being viewed at the ONT (e.g., the address of an IP video channel). As is known in the art, an ONT may support or otherwise connect more than one set-top box (STB). As such, the process 1900 may be said to receive (1920) video services (or the addresses of IP video channels) being viewed at all STBs which are connected to the ONT.

Having received (1920) the indication for video services being viewed at the ONT, the process 1900 continues to reboot (1925) the ONT. The process 1900 sends (1930) video services according to the indication of video services being viewed at the ONT.

The process 1900 starts (1935) a timing mechanism (or timer) for video services the receipt of which are enabled. The timing mechanism for video services has a default value, which in some instances may be stored by or otherwise communicated to the process 1900.

The process 1900 waits (1940) for a video service query from a video services server. The process 1900 determines (1945) whether it has received a video service query from the video services server. In an event the process 1900 determines (1945) it has received a query for video services, the process 1900 responds (1950) with video services, the receipt of which are enabled at the ONT. For example, the process 1900 returns address of all applicable IP video channels being viewed by the ONT.

Recall that while an ONT may not yet be ranged and provisioned for upstream communications with an OLT (i.e., messages or data cannot be sent from the ONT to the OLT), downstream communications with the ONT may still be possible, and video services may still be viewed by the ONT. Such an ONT may be conveniently referred to as a “temporarily offline ONT.” Accordingly, in some instances, the process 1900 responds (1950) with video services by returning address of all applicable IP video channels being viewed by the temporarily offline ONT.

As described in reference to FIGS. 16 and 17, a response to a video service query from a video services server indicates to the server which video services are being viewed at an ONT. Furthermore, such a response indicates a “status quo” condition to the server and that video services are to continue to be sent towards the ONT. As such, the process 1900, by responding (1950), indicates that video services are to continue to be sent towards the ONT. Additionally, by responding (1950), the process 1900 may be said to perform an “ONT/STB proxy function” for the ONT (also described in reference to FIGS. 16 and 17).

Despite indicating that video services are to continue to be sent towards the ONT, the process 1900 determines (1955) whether the timing mechanism for video services has expired. That is, whether the process 1900 can continue to send video services towards the ONT. In an event the process 1900 determines (1955) that the timing mechanism for video services has expired, the process 1900 stops (1960) sending video services.

In some instances, the stopped video services may be an IP video channel sent over a “flow” which is directed to a specific ONT-ID on a PON. That is, video services are provided to each ONT (customer) over individual downstream communications paths as described in reference to FIG. 9. Note, in such instances the flow is still directed to the ONT-ID even if the ONT is not ranged and is incapable of upstream communications (i.e., the ONT is a temporarily offline ONT).

In other instances, the process 1900 stops (1960) sending video services by stop sending video services towards a PON itself. In such instances, the stopped video services may be an IP video channel, sent over a downstream communications path, which is “broadcast” in nature, as described in reference to FIG. 10.

Continuing to refer to FIG. 19, in an event the process 1900 determines (1955) that the timing mechanism for video services has not expired, the process 1900 determines (1965) whether the ONT has been re-ranged (i.e., capable of upstream communications). In an event the process 1900 determines (1965) that the ONT has been re-ranged, the process 1900 stops (1970) responding to a query for video services from the video services server. As such, the process 1900 may be said to stop performing the ONT/STB proxy function for the ONT in an event ONT has been re-ranged.

Returning to the process 1900 determining (1945) whether it has received a query from the video services server. In an event the process 1900 determines (1945) that it has not received a query from the video services server, the process 1900 determines (1955) whether the timing mechanism for video services has expired. The process 1900 then continues as previously described.

The process 1900 then determines (1965) whether the ONT has been re-ranged. In an event the process 1900 determines (1965) that the ONT has not been re-ranged, the process 1900 starts (1935) the timing mechanism for video services receipt. The process 1900 then continues as previously described.

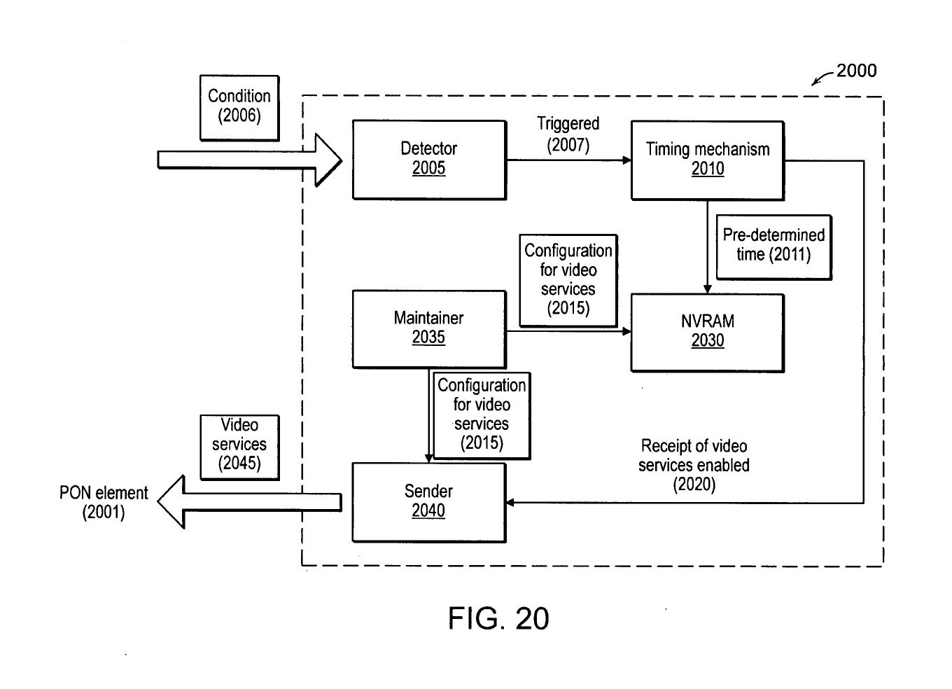

FIG. 20 illustrates an example system 2000 to ensure continuous receipt of video services at a PON element 2001, such as an ONT. The system 2000 includes a detector 2005 to detect a condition 2006 indicating a change of state in receipt of video services at the PON element 2001. Connected to the detector 2005 is a timing mechanism 2010 to enable receipt of video services at the PON element 2001 for a predetermined (or dynamic) amount of time 2011.

In an event the detector 2005 detects the condition 2006 indicating a change of state in receipt of video services at the PON element 2001, such as a loss of ranging or a loss of signal, the timing mechanism 2010 is triggered (2007). The timing mechanism 2010 enables receipt of video services (2020). The system 2000 enables (2020) receipt of video services at the PON element 2001 for the predetermined amount of time 2011. In one embodiment of the present invention, the timing mechanism 2010 disables receipt of video services at the PON element 2001 when the predetermined amount of time 2011 expires. It should be understood that receipt of video services may also be disabled after a predetermined amount of time by disabling transmission of video services towards a customer or subscriber.

The timing mechanism 2010 may be connected to a nonvolatile random access memory (NVRAM) 2030 or FLASH. The NVRAM 2030 stores the predetermined amount of time 2011. While the predetermined amount of time 2011 may be stored internally in (or “internal to”) the system 2000, the predetermined amount of time 2011 may be changed by a remote or external source (not shown).

The system 2000 may also include a maintainer 2035 to maintain a configuration for video services 2015 in a manner described in reference to FIGS. 16 and 17. The NVRAM 2030 may be connected to the maintainer 2035 to maintain or otherwise store the maintained configuration for video services 2015.

The system 2000 may also include a sender 2040 to send video services 2045 to the PON element 2001 according to the maintained configuration for video services 2015. The timing mechanism 2010 may be in communication with to the sender 2040. In this way, receipt of the video services 2045 is enabled for the predetermined amount of time 2011, and the video services 2045 are sent according to the maintained configuration for video services 2015.

One or more of the above elements may be implemented in a microprocessor, such as the microprocessor of FIG. 2. Alternatively, one or more of the above elements may be implemented in software written to be executed by the microprocessor. One skilled in the art will really recognize that where the above elements are implemented may not be of significance in some embodiments, but rather what functions are performed by the above elements may be of significance in these embodiments.

While this invention has been particularly shown and described with references to preferred embodiments thereof, it will be understood by those skilled in the art that various changes in form and details may be made therein without departing from the scope of the invention encompassed by the appended claims.

For example, although described as “cards” herein, it should be understood that PON cards, OLT cards, or ONT cards may be systems or subsystems without departing from the principles disclosed hereinabove.

Also, a timer or timing mechanism (e.g., the timer 225 of FIG. 2 and the timing mechanism 1510 of FIG. 15) may be a count-up timer, count-down timer, or any form of timer that can be used for maintaining an ONT in an enabled state for a given length of time.

Although described in reference to a passive optical network, the same or other embodiments of the present invention may be employed in an active optical network, data communications network, or any other type of network.

An OLT may receive, for example, an indication of video services being viewed at an ONT (described above in reference to FIG. 18) or a configuration for video services as maintained by the ONT, via one or more messages. The messages may be, for example, an ONT Management and Control Interface (OMCI) message, Physical Layer Operation Administration and Maintenance (PLOAM) message, or a combination thereof.

OMCI is a “service-level” protocol that, amongst other things, specifies ONT management and messages exchanged between an OLT and an ONT for provisioning and setting up services at the ONT. The term service-level in this context refers to a high-level protocol contrasted with the other lower-level protocols which comprise the ONT “protocol stack.”

As well understood by persons skilled in the art to which example embodiments of present invention relate, a protocol stack is a group or suite of software elements, each itself defined by a protocol, which interact or communicate with each other in conformance with a protocol to which they collectively relate.

PLOAM, on the other hand, is a protocol used at the Transmission Convergence (TC) layer of the ONT protocol stack, which is near the bottom of the ONT protocol stack, near the hardware interface. The TC layer is defined by the G.984.x and G.983.x specifications and is adjacent to the physical medium-dependent layer, which is defined by the G.984.2 and G.984.1 specifications, both of which are familiar to persons skilled in the art.

One of ordinary skill in the art will readily recognize, example embodiments of the present invention are not intended to be limited by the above. Rather, example embodiments of the present invention are applicable to other messages known in the art.

It should be understood that the block diagrams and flowcharts (e.g., FIGS. 16 and 19) may include more or fewer elements, be arranged differently, or be represented differently. It should be understood that implementation may dictate the block diagrams and flowcharts and the number of block diagrams and flowcharts illustrating the execution of embodiments of the invention.

It should be further understood that elements of the block diagrams and flowcharts (e.g., FIGS. 16 and 19) described above may be implemented in software, hardware, or firmware. In addition, the elements of the block/flow/network diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

What is claimed is:

1. A method of ensuring continuous video services based on certain conditions in a passive optical network (PON), the method comprising:
detecting at a PON element a condition indicating a change of states in video services;
triggering a timing mechanism having a default value stored in the PON element; and
enabling receipt of video services at the PON element for an amount of time defined by the default value.

2. The method according to claim 1 wherein enabling receipt of video services at the PON element for the amount of time defined by the default value includes:
maintaining at a second PON element a configuration for video services for the amount of time defined by the default value and;
sending video services to the PON element according to the maintained configuration for video services for the amount of time defined by the default value.

3. The method according to claim 2 wherein maintaining at the second PON element the configuration for video services includes responding to queries from a video services server indicating to the video services server that receipt of video services at the PON element are enabled.

4. The method according to claim 2 wherein maintaining at the second PON element the configuration for video services includes providing updates to a video services server informing the video services server that receipt of video services at the PON element are enabled.

5. The method according to claim 2 wherein maintaining at the second PON element the configuration for video services includes stop maintaining the configuration for video services in an event the PON element is un-ranged after the amount of time defined by the default value.

6. The method according to claim 2 wherein sending video services to the PON element includes sending video services to the PON element even though the PON element is un-ranged and not capable of upstream communications.

7. The method according to claim 6 wherein sending video services to the PON element includes discontinuing sending video services to the PON element in an event the PON element is un-ranged after the amount of time defined by the default value.

8. The method according to claim 2 further comprising receiving at the second PON element at least an indication of video services being viewed at the PON element.

9. The method according to claim 8 further comprising requesting at the second PON element for at least an indication of video services being viewed at the PON element.

10. The method according to claim 8 wherein receiving at the second PON element at least an indication of video services being viewed at the PON element includes monitoring for a message indicating video services are being viewed at the PON element.

11. The method according to claim 1 further comprising changing the default value of the timing mechanism from a remote or external source.

12. The method according to claim 1 further comprising storing the default value of the timing mechanism in nonvolatile memory.

13. The method according to claim 1 wherein the change of states includes at least one of the following:
fiber-break in certain segments of the PON;
the PON element reboots for purposes of troubleshooting or upgrading the PON element;
the PON card or other line card reboots or is replaced with another line card;
poor connections with some Optical Distribution Network (ODN); or
a misbehaving PON element causes faulty communications between PON elements.

14. The method according to claim 1 further comprising returning the timing mechanism to its original state in an event a loss of ranging occurs.

15. The method according to claim 1 further comprising disabling receipt of video services after the amount of time defined by the timing mechanism expires.

16. The method according to claim 1 further comprising disabling transmission of video services toward a customer after the amount of time defined by the timing mechanism expires.

17. A system to ensure continuous receipt of video services at a PON element based on certain conditions in a PON, the system comprising:
a detector to detect a condition indicating a change of states in receipt of video services; and
a timing mechanism connected to the detector to enable receipt of video services at the PON element for a predetermined amount of time.

18. The system according to claim 17 wherein the timing mechanism disables receipt of video services at the PON element after the predetermined amount of time.

19. The system according to claim 17 wherein the timing mechanism disables transmission of the video services toward a customer after the predetermined amount of time.

20. The system according to claim 17 wherein the value of the predetermined amount of time is changed by a remote or external source.

21. The system according to claim 17 wherein the change of states includes at least one of the following:
fiber-break in certain segments of the PON;
the PON element reboots for purposes of troubleshooting or upgrading the PON element;
the PON card or other line card reboots or is replaced with another line card;
poor connections with some Optical Distribution Network (ODN); and
a misbehaving PON element causes faulty communications between PON elements.

22. The system according to claim 17 further comprising;
a maintainer to maintain a configuration for video services for the amount of time defined by the default value; and
a sender to send video services to the PON element according to the maintained configuration for video services for the amount of time defined by the default value.

23. The system according to claim 17 further comprising nonvolatile memory connected to the maintainer to store the maintained configuration for video services.

24. The system according to claim 23 wherein the nonvolatile memory is connected to the timing mechanism to store a value of the predetermined amount of time.

25. A computer program product comprising a computer usable medium embodying computer usable code to ensure continuous video services based on certain conditions in a passive optical network (PON), the computer program product including computer usable program code, which when executed by a processor, causes the processor to:
detect at a PON element a condition indicating a change of states in video services;
trigger a timing mechanism having a default value stored in the PON element; and
enable receipt of video services at the PON element for an amount of time defined by the default value.
